(19) United States
(12) Patent Application Publication
(10) Pub. No.: US 2024/0364454 A1
(43) Pub. Date: Oct. 31, 2024

(54) FLEXIBLE CYCLIC REDUNDANCY CHECK FOR DOWNLINK CONTROL CHANNELS

(71) Applicant: QUALCOMM Incorporated, San Diego, CA (US)

(72) Inventors: Mostafa KHOSHNEVISAN, San Diego, CA (US); Kazuki TAKEDA, Minato-ku (JP)

(21) Appl. No.: 18/309,241

(22) Filed: Apr. 28, 2023

(51) Int. Cl. H04L 1/00; H04W 72/23

(52) U.S. Cl. CPC H04L 1/0061; H04W 72/23

(57) ABSTRACT

Methods, systems, and devices for wireless communications are described. The described techniques provide for flexible cyclic redundancy check (CRC) lengths for downlink control information (DCI) message. For example, a network entity may determine a length of a CRC applied to a DCI message based on an attribute of the DCI message. In some examples, relationships between attributes of the DCI message and CRC lengths may be stored or configured at a user equipment (UE) or may be indicated to the UE via additional control signaling from the network entity. In some examples, the UE may transmit, to the network entity, a capability of the UE to support flexible CRC lengths for DCI messages. Varying the length of the CRC applied to the DCI message based on one or more attributes of the DCI message may enable the network entity to effectively balance overhead, payload size, and frequency of false alarms.

### FIELD OF TECHNOLOGY

The following relates to wireless communications, including flexible cyclic redundancy check (CRC) for downlink control channels.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support multiple flexible cyclic redundancy check (CRC) lengths for downlink control information (DCI) messages. For example, a network entity may determine a length of a CRC applied to a DCI message based on (e.g., as a function of) one or more attributes of the DCI message. In some examples, relationships between attributes of the DCI message and CRC lengths may be stored or configured at a user equipment (UE), or may be indicated to the UE via additional control signaling (e.g., radio resource control (RRC) signaling) from the network entity. Thus, a UE may receive a DCI message and may perform a redundancy check associated with the DCI message based on a CRC, where the length of the CRC is based on the one or more attributes. Varying the length of CRCs applied to DCI messages may enable the network entity to effectively balance overhead, payload size, and frequency of false alarms.

A method for wireless communications at a UE is described. The method may include monitoring a search space for a first downlink control message, receiving the first downlink control message based on the monitoring, and performing a redundancy check associated with the first downlink control message based on a first CRC, where a length of the first CRC is based on one or more transmission characteristics of the first downlink control message.

An apparatus for wireless communications at a UE is described. The apparatus may include at least one processor, memory coupled with (e.g., operatively, communicatively, functionally, electronically, or electrically) the at least one processor, and instructions stored in the memory. The instructions may be executable by the at least one processor (e.g., directly, indirectly, after pre-processing, without pre-processing) to cause the UE to monitor a search space for a first downlink control message, receive the first downlink control message based on the monitoring, and perform a redundancy check associated with the first downlink control message based on a first CRC, where a length of the first CRC is based on one or more transmission characteristics of the first downlink control message.

Another apparatus for wireless communications at a UE is described. The apparatus may include means for monitoring a search space for a first downlink control message, means for receiving the first downlink control message based on the monitoring, and means for performing a redundancy check associated with the first downlink control message based on a first CRC, where a length of the first CRC is based on one or more transmission characteristics of the first downlink control message.

A non-transitory computer-readable medium storing code for wireless communications at a UE is described. The code may include instructions executable by at least one processor (e.g., directly, indirectly, after pre-processing, without pre-processing) to monitor a search space for a first downlink control message, receive the first downlink control message based on the monitoring, and perform a redundancy check associated with the first downlink control message based on a first CRC, where a length of the first CRC is based on one or more transmission characteristics of the first downlink control message.

In some examples of the method, apparatuses, and non-transitory computer-readable medium described herein, the length of the first CRC may be from a set of defined lengths of CRCs and each length of the set of defined lengths may be associated with one or more values of the one or more transmission characteristics.

Some examples of the method, apparatuses, and non-transitory computer-readable medium described herein may further include operations, features, means, or instructions for receiving a configuration message indicating the associations between the set of defined lengths and the one or more values of the one or more transmission characteristics.

Some examples of the method, apparatuses, and non-transitory computer-readable medium described herein may further include operations, features, means, or instructions for receiving a configuration message indicating the length of the first CRC.

Some examples of the method, apparatuses, and non-transitory computer-readable medium described herein may further include operations, features, means, or instructions for receiving a configuration message indicating a polynomial associated with generating the first CRC, where the length of the first CRC may be based on the polynomial associated with generating the first CRC.

In some examples of the method, apparatuses, and non-transitory computer-readable medium described herein, the one or more transmission characteristics include one or more component carriers used to transmit the first downlink control message, one or more bandwidth parts (BWPs) used to transmit the first downlink control message, a subcarrier spacing (SCS) used to transmit the first downlink control message, a control resource set (CORESET) associated with the search space, the search space, an aggregation level (AL) associated with the first downlink control message, a size of a payload of the first downlink control message, a DCI format of the first downlink control message, a radio network temporary identifier (RNTI) associated with the first downlink control message, or any combination thereof.

Some examples of the method, apparatuses, and non-transitory computer-readable medium described herein may further include operations, features, means, or instructions for receiving a second downlink control message based on receiving the first downlink control message and performing a redundancy check associated with the second downlink control message based on a second CRC, where a length of the second CRC may be based on one or more transmission characteristics associated with the second downlink control message.

In some examples of the method, apparatuses, and non-transitory computer-readable medium described herein, the length of the first CRC may be different than the length of the second CRC.

In some examples of the method, apparatuses, and non-transitory computer-readable medium described herein, the length of the first CRC may be different than the length of the second CRC based on a format or a RNTI associated with the first downlink control message being different than a format or a RNTI associated with the second downlink control message.

In some examples of the method, apparatuses, and non-transitory computer-readable medium described herein, the first downlink control message may be a first stage DCI and the second downlink control message may be a second stage DCI.

In some examples of the method, apparatuses, and non-transitory computer-readable medium described herein, the first downlink control message may be received on a downlink control channel monitoring occasion and the second downlink control message may be multiplexed with a downlink data channel.

Some examples of the method, apparatuses, and non-transitory computer-readable medium described herein may further include operations, features, means, or instructions for transmitting a capability message indicating a capability of the UE to support a set of multiple lengths of CRCs associated with a set of multiple downlink control messages.

In some examples of the method, apparatuses, and non-transitory computer-readable medium described herein, the capability message further indicates a numerical quantity of lengths of CRCs supported by the UE.

In some examples of the method, apparatuses, and non-transitory computer-readable medium described herein, the numerical quantity of lengths of CRC may be based on a SCS associated with the UE, one or more component carriers associated with the UE, one or more slots associated with the UE per component carrier, one or more monitoring occasions associated with the UE per component carrier, or any combination thereof.

In some examples of the method, apparatuses, and non-transitory computer-readable medium described herein, the capability may be based on a frequency band associated with the UE, a frequency band combination associated with the UE, a frequency band associated with the UE per frequency band combination, a component carrier associated with the UE per frequency band per frequency band combination, or any combination thereof.

A method for wireless communications at a network entity is described. The method may include identifying data for transmission in a first downlink control message, applying a first CRC to the data, where a length of the first CRC is based on one or more transmission characteristics associated with the first downlink control message, and transmitting the first downlink control message via a search space based on applying the first CRC.

An apparatus for wireless communications at a network entity is described. The apparatus may include at least one processor, memory coupled with (e.g., operatively, communicatively, functionally, electronically, or electrically) the at least one processor, and instructions stored in the memory. The instructions may be executable by the at least one processor (e.g., directly, indirectly, after pre-processing, without pre-processing) to cause the network entity to identify data for transmission in a first downlink control message, apply a first CRC to the data, where a length of the first CRC is based on one or more transmission characteristics associated with the first downlink control message, and transmit the first downlink control message via a search space based on applying the first CRC.

Another apparatus for wireless communications at a network entity is described. The apparatus may include means for identifying data for transmission in a first downlink control message, means for applying a first CRC to the data, where a length of the first CRC is based on one or more transmission characteristics associated with the first downlink control message, and means for transmitting the first downlink control message via a search space based on applying the first CRC.

A non-transitory computer-readable medium storing code for wireless communications at a network entity is described. The code may include instructions executable by at least one processor (e.g., directly, indirectly, after pre-processing, without pre-processing) to identify data for transmission in a first downlink control message, apply a first CRC to the data, where a length of the first CRC is based on one or more transmission characteristics associated with the first downlink control message, and transmit the first downlink control message via a search space based on applying the first CRC.

In some examples of the method, apparatuses, and non-transitory computer-readable medium described herein, the length of the first CRC may be from a set of defined lengths of CRCs and each length of the set of defined lengths may be associated with one or more values of the one or more transmission characteristics.

Some examples of the method, apparatuses, and non-transitory computer-readable medium described herein may further include operations, features, means, or instructions for transmitting a configuration message indicating the associations between the set of defined lengths and the one or more values of the one or more transmission characteristics.

Some examples of the method, apparatuses, and non-transitory computer-readable medium described herein may further include operations, features, means, or instructions for transmitting a configuration message indicating the length of the first CRC.

Some examples of the method, apparatuses, and non-transitory computer-readable medium described herein may further include operations, features, means, or instructions for transmitting a configuration message indicating a polynomial associated with generating the first CRC, where the length of the first CRC may be based on the polynomial associated with generating the first CRC.

In some examples of the method, apparatuses, and non-transitory computer-readable medium described herein, the one or more transmission characteristics include one or more component carriers used to transmit the first downlink control message, one or more BWPs used to transmit the first downlink control message, a SCS used to transmit the first downlink control message, a CORESET associated with the search space, the search space, an AL associated with the first downlink control message, a size of a payload of the first downlink control message, a DCI format of the first downlink control message, a RNTI associated with the first downlink control message, or any combination thereof.

Some examples of the method, apparatuses, and non-transitory computer-readable medium described herein may further include operations, features, means, or instructions for identifying second data for transmission in a second downlink control message, applying a second CRC to the second data, where a length of the second CRC may be based on one or more transmission characteristics associated with the second downlink control message, and transmitting the second downlink control message based on transmitting the first downlink control message.

In some examples of the method, apparatuses, and non-transitory computer-readable medium described herein, the length of the first CRC may be different than the length of the second CRC.

In some examples of the method, apparatuses, and non-transitory computer-readable medium described herein, the length of the first CRC may be different than the length of the second CRC based on a format or a RNTI associated with the first downlink control message being different than a format or a RNTI associated with the second downlink control message.

In some examples of the method, apparatuses, and non-transitory computer-readable medium described herein, the first downlink control message may be first stage DCI and the second downlink control message may be second stage DCI.

In some examples of the method, apparatuses, and non-transitory computer-readable medium described herein, the first downlink control message may be received on a downlink control channel monitoring occasion and the second downlink control message may be multiplexed with a downlink data channel.

Some examples of the method, apparatuses, and non-transitory computer-readable medium described herein may further include operations, features, means, or instructions for receiving a capability message indicating a capability of a UE to support a set of multiple lengths of CRCs associated with a set of multiple downlink control messages.

In some examples of the method, apparatuses, and non-transitory computer-readable medium described herein, the capability message further indicates a numerical quantity of lengths of CRCs supported by the UE.

In some examples of the method, apparatuses, and non-transitory computer-readable medium described herein, the numerical quantity of lengths of CRC may be based on a SCS associated with the UE, one or more component carriers associated with the UE, one or more slots associated with the UE per component carrier, one or more monitoring occasions associated with the UE per component carrier, or any combination thereof.

In some examples of the method, apparatuses, and non-transitory computer-readable medium described herein, the capability may be based on a frequency band associated with the UE, a frequency band combination associated with the UE, a frequency band associated with the UE per frequency band combination, a component carrier associated with the UE per frequency band per frequency band combination, or any combination thereof.

### BRIEF DESCRIPTION OF THE DRAWINGS

FIG. 1 shows an example of a wireless communications system that supports flexible cyclic redundancy check (CRC) for downlink control channels in accordance with one or more aspects of the present disclosure.

FIG. 2 shows an example of a wireless communications system that supports flexible CRC for downlink control channels in accordance with one or more aspects of the present disclosure.

FIG. 3 shows an example of a timing diagram that supports flexible CRC for downlink control channels in accordance with one or more aspects of the present disclosure.

FIG. 4 shows an example of a process flow that supports flexible CRC for downlink control channels in accordance with one or more aspects of the present disclosure.

FIGS. 5 and 6 show block diagrams of devices that support flexible CRC for downlink control channels in accordance with one or more aspects of the present disclosure.

FIG. 7 shows a block diagram of a communications manager that supports flexible CRC for downlink control channels in accordance with one or more aspects of the present disclosure.

FIG. 8 shows a diagram of a system including a device that supports flexible CRC for downlink control channels in accordance with one or more aspects of the present disclosure.

FIGS. 9 and 10 show block diagrams of devices that support flexible CRC for downlink control channels in accordance with one or more aspects of the present disclosure.

FIG. 11 shows a block diagram of a communications manager that supports flexible CRC for downlink control channels in accordance with one or more aspects of the present disclosure.

FIG. 12 shows a diagram of a system including a device that supports flexible CRC for downlink control channels in accordance with one or more aspects of the present disclosure.

FIGS. 13 through 18 show flowcharts illustrating methods that support flexible CRC for downlink control channels in accordance with one or more aspects of the present disclosure.

### DETAILED DESCRIPTION

In some wireless communications systems, a transmitting device may encode signaling prior to transmission. In such cases, the transmitting device may include (e.g., append) a quantity of cyclic redundancy check (CRC) bits to the signaling prior so that a receiving device can confirm that the signaling was correctly received and decoded. A longer CRC (e.g., with a greater quantity of CRC bits) may decrease a probability of the receiving device incorrectly determining if the signaling was correctly decoded, but may increase overhead and processing at the receiving device. Conversely, a shorter CRC may increase a probability of the receiving device incorrectly determining if the signaling was correctly decoded, but may decrease overhead and processing at the receiving device. An instance of incorrectly determining if the signaling was correctly decoded may be referred to as a false alarm.

In a downlink example, a network entity may transmit, to the UE, downlink control information (DCI) messages with CRCs of a fixed length (e.g., 24 bits). However, transmitting DCI messages with the CRCs of the fixed length may increase overhead and processing at the UE and may limit a quantity of bits which may be allocated for other purposes. That is, a CRC of the fixed length may not be optimal for all DCI formats. For example, a false alarm for decoding some DCI messages (e.g., associated with a first set of DCI formats) may impact a success of future communications of the UE, thus, the fixed length of the CRC may result in a tolerable quantity of false alarms (e.g., below a threshold quantity). However, a false alarm for decoding some other DCI messages (e.g., associated with a second set of DCI formats) may not impact the success of future communications of the UE, and thus the tolerable quantity of false alarms may be relatively higher than for the first set of DCI formats. Thus, decoding of the CRC of the fixed length may result in unnecessary overhead and processing at the UE due to the second set of DCI formats being able to tolerate a higher quantity of false alarms. Additionally, or alternatively, the UE may determine if some DCI messages (e.g., multiplexed or two-stage DCIs) have been successfully decoded using a CRC of a length shorter than the fixed length, resulting in increased overhead and processing at the UE from decoding the CRC of the fixed length. Additionally, or alternatively, some DCI messages (e.g., DCI scheduling multi-component carrier transmissions) may be associated with a bit length which may not exceed a threshold quantity (e.g., 164 bits). Therefore, the CRC of the fixed length may use more of the threshold quantity of bits than necessary, which may decrease the quantity of bits which may be allocated for a payload of the DCI message. Thus, the fixed CRC length for DCI messages may increase overhead and processing at the UE and may limit the quantity of bits which may be allocated for other purposes.

Accordingly, techniques described herein may enable flexible CRC lengths for DCI messages. For example, the network entity may select a length of a CRC (e.g., CRC length) applied to a DCI message based on (e.g., as a function of) one or more attributes of the DCI message. For example, the network entity may select the length of the CRC based on one or more of a DCI format of the DCI message, a component carrier over which the DCI message is received, a bandwidth part (BWP) over which the DCI message is received, a subcarrier spacing (SCS) of the component carrier or the BWP, a control resource set (CORESET) over which the DCI message is received, a search space set over which the DCI message is received, an aggregation level (AL) of the DCI message, or a payload size of the DCI message. Additionally, or alternatively, the network entity may select the length of the CRC based on if the DCI message is multiplexed (e.g., piggybacked) with an additional message or part of a two-stage DCI message transmission. In some examples, relationships between DCI message attributes and CRC lengths may be stored or configured at the UE or may be indicated to the UE via additional control signaling (e.g., radio resource control (RRC) signaling) from the network entity. As such, varying the length of the CRC applied to the DCI message based on one or more attributes of the DCI message may enable the network entity to effectively balance overhead, payload size, and frequency of false alarms.

Aspects of the disclosure are initially described in the context of wireless communications systems. Aspects of the disclosure are further described in the context of a timing diagram and a process flow. Aspects of the disclosure are further illustrated by and described with reference to apparatus diagrams, system diagrams, and flowcharts that relate to flexible CRC for downlink control channels.

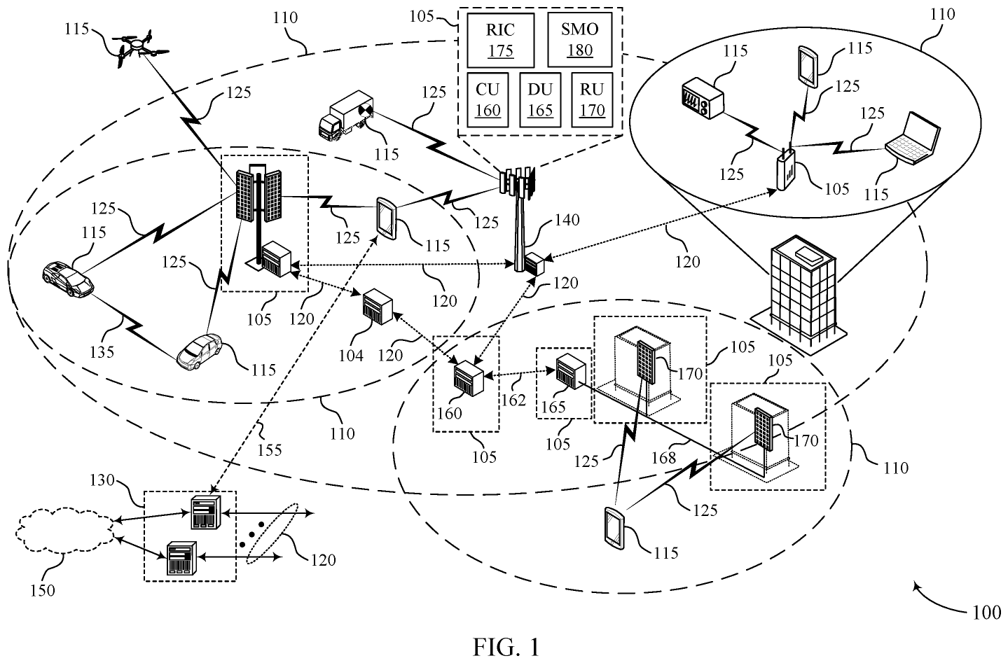

FIG. 1 shows an example of a wireless communications system 100 that supports flexible CRC for downlink control channels in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support flexible CRC for downlink control channels as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a CORESET) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Techniques described herein may enable flexible CRC lengths for DCI messages. For example, a network entity 105 may select a length of a CRC applied to a DCI message based on (e.g., as a function of) one or more attributes of the DCI message. For example, the network entity 105 may select the length of the CRC based on one or more of a DCI format of the DCI message, a component carrier over which the DCI message is received, a BWP over which the DCI message is received, an SCS of the component carrier or of the BWP, a CORESET or search space set over which the DCI message is received, an AL of the DCI message, or a payload size of the DCI message. Additionally, or alternatively, t network entity 105 may select the length of the CRC based on if the DCI message is multiplexed (e.g., piggybacked) with another message or part of a two-stage DCI message transmission. In some examples, relationships between DCI message attributes and CRC lengths may be stored or configured at a UE 115 or may be indicated to the UE 115 via additional control signaling (e.g., RRC signaling) from the network entity 105. In some examples, the UE 115 may transmit, to the network entity 105, a capability of the UE 115 to support flexible CRC lengths for DCI messages. As such, varying the length of the CRC applied to the DCI message based on one or more attributes of the DCI message may enable the network entity 105 to effectively balance overhead, payload size, and frequency of false alarms.

Although aspects of the disclosure are described with reference to CRCs applied to DCI messages, the principles of this disclosure also may be applicable to other signaling types, such as other physical downlink control channel (PDCCH) transmissions, PUSCH transmissions, physical downlink shared channel (PDSCH) transmissions, transport blocks (TBs), uplink control information (UCI), or physical broadcast channel (PBCH) transmissions.

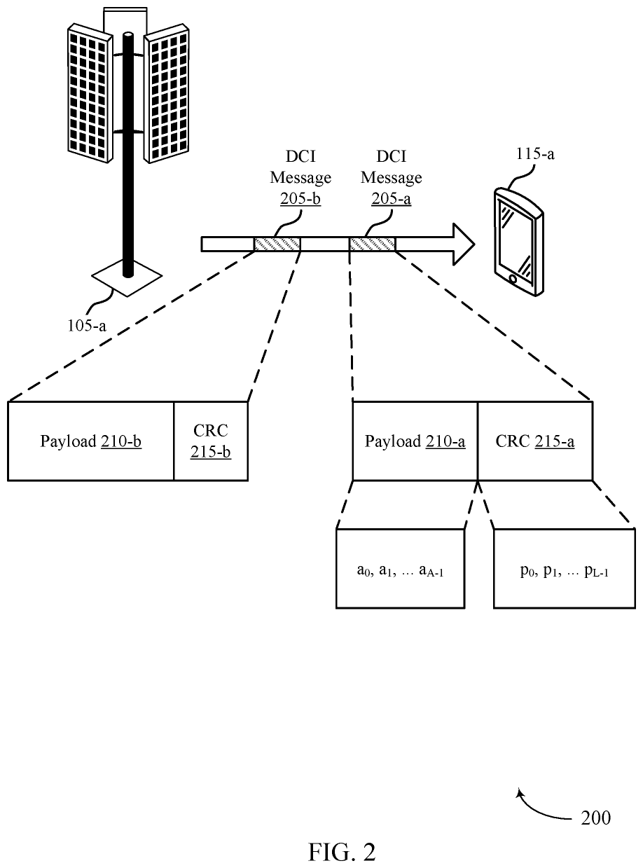

FIG. 2 shows an example of a wireless communications system 200 that supports flexible CRC for downlink control channels in accordance with one or more aspects of the present disclosure. In some cases, the wireless communications system 200 may implement or be implemented by aspects of the wireless communications system 100. For example, the wireless communications system 200 may include a UE 115 (e.g., a UE 115-a) and a network entity 105 (e.g., a network entity 105-a), which may be examples of the corresponding devices as described with reference to FIG. 1.

In some wireless communications systems, such as the wireless communications system 200, a transmitting device, such as a network entity 105-a, may encode signaling (e.g., by performing interleaving or polar encoding) prior to transmission. In such cases, the network entity 105-a may include (e.g., append) CRC 215 bits to the signaling prior to encoding the signaling to support error detection (e.g., protection). That is, the network entity 105-a may append (e.g., attach or apply) the CRC 215 to a payload 210 (e.g., information bits) before encoding the signaling, such that a receiving device, such as a UE 115-a, may determine if the UE 115-a successfully decoded the signaling based on checking the CRC 215 after decoding, which may be referred to as performing a redundancy check. The network entity 105-a may apply CRCs 215 for low density parity check (LDPC) codes (e.g., PUSCH or PDSCH transmissions) as well as polar codes (e.g., DCI message 205 or UCI).

In some cases, a CRC 215 may include a large quantity of bits which may increase overhead and processing at the UE 115-a but may result in fewer instances of incorrectly determining that decoding is successful (e.g., a lower false alarm rate), which may be referred to as false alarms, as compared to a CRC 215 with a smaller quantity of bits. In other words, a false alarm may occur when the UE 115-a assumes it successfully decodes a signal as a result of incorrectly determining that the CRC 215 matches a CRC 215 that the UE 115-a expected to receive (e.g., but the signal is either not present or is not intended for the UE). The UE 115-a may incorrectly determine that the CRC 215 of the signal matches the CRC 215 that the UE 115-a expected to receive, for example, if the CRC 215 is short (e.g., or if there is no CRC 215). A false alarm may occur due to noise, due to the UE 115-a decoding a transmission which is not intended for the UE 115-a (e.g., the UE 115-a decoding a DCI message 205 for another UE 115 or a different radio network temporary identifier (RNTI)), or both. Alternatively, the CRC 215 with the smaller quantity of bits may be associated with decreased overhead and processing at the UE 115-a but may result in more instances of false alarms (e.g., a higher false alarm rate) as compared to the CRC 215 with the larger quantity of bits.

The network entity 105-a may generate a CRC 215 using a CRC generator polynomial. For example, the network entity 105-a may generate a CRC 215 for a first set of transmission types (e.g., TBs or code blocks (CBs) for PUSCH or PDSCH transmissions, DCI, or PBCH transmissions) using a 24^{th} order polynomial, such as one of the 24^{th} order polynomials of Equations 1, 2, or 3 below. For example, the network entity 105-a may use a first 24^{th} order polynomial, g_{CRC24A}(D), of Equation 1 to determine a first CRC 215 with a length of 24 bits for a TB with a TB size (TBS) which is greater than a threshold (e.g., 3824 bits). The network entity 105-a may use a second 24^{th} order polynomial, g_{CRC24B}(D), of Equation 2 to determine a second CRC 215 with a length of 24 bits for a CB for a TB with more than one CB. The network entity 105-a may use a third 24^{th} order polynomial, g_{CRC24C}(D), of Equation 3 to determine a CRC 215 with a length of 24 bits for DCI messages 205 or PBCH transmissions.

$${g}_{CRC 24 A} ( D ) = {D}^{24} + {D}^{23} + {D}^{18} + {D}^{17} + {D}^{14} + {D}^{11} + {D}^{10} + {D}^{7} + {D}^{6} + {D}^{5} + {D}^{4} + {D}^{3} + D + 1 \qquad ( 1 )$$

$${g}_{CRC 24 B} ( D ) = {D}^{24} + {D}^{23} + {D}^{6} + {D}^{5} + D + 1 \qquad ( 2 )$$

$${g}_{CRC 24 C} ( D ) = {D}^{24} + {D}^{23} + {D}^{21} + {D}^{20} + {D}^{17} + {D}^{15} + {D}^{12} + {D}^{8} + {D}^{4} + {D}^{2} + D + 1 \qquad ( 3 )$$

In some examples, the network entity 105-a may use a 16^{th} order polynomial, such as a 16^{th} order polynomial of Equation 4, to generate a CRC 215 for a second set of transmission types (e.g., TBs for PUSCH or PDSCH transmissions). For example, for a TB with a TBS which is less than a threshold (e.g., 3824 bits), the network entity 105-a may use the 16^{th} order polynomial, g_{CRC16}(D), of Equation 4 to generate a CRC 215 with a length of 16 bits.

$${g}_{CRC 16} ( D ) = {D}^{16} + {D}^{12} + {D}^{5} + 1 \qquad ( 4 )$$

In some examples, the network entity 105-a may use an 11^{th} order polynomial, such as an 11^{th} order polynomial of Equation 5, to generate a CRC 215 for a third set of transmission types (e.g., UCI messages). For example, for a UCI message with a payload 210 which is greater than a threshold (e.g., 20 bits), the network entity 105-a may use the 11^{th} order polynomial, g_{CRC11}(D), of Equation 5 to generate a CRC 215 with a length of 11 bits.

$${g}_{CRC 11} ( D ) = {D}^{11} + {D}^{10} + {D}^{9} + {D}^{5} + 1 \qquad ( 5 )$$

In some examples, the network entity 105-a may use a 6^{th} order polynomial, such as a 6^{th} order polynomial of Equation 6, to generate the CRC 215 for a fourth set of transmission types (e.g., UCI messages). For example, for a UCI message with a payload 210 which falls within a range (e.g., between 12 and 19 bits), the network entity 105-a may use the 6^{th} order polynomial, g_{CRC6}(D), of Equation 6 to generate a CRC 215 with a length of 6 bits.

$${g}_{CRC 6} ( D ) = {D}^{6} + {D}^{5} + 1 \qquad ( 6 )$$

In Equations 1, 2, 3, 4, 5, and 6, the parameter D may represent a unitless, or dummy, variable used for calculation of a CRC 215.

For example, the network entity 105-a may calculate bits (e.g., parity bits) of a CRC 215 for a DCI message 205 using a payload 210 (e.g., the entire payload 210, including bits a₀, a₁, . . . a_{A-1}, where A is a length of the payload 210) of the DCI message 205. That is, the network entity 105-a may use a quantity L of bits (e.g., L dummy bits set to 1 or set to 0), the payload 210-a, and a Lth order polynomial (e.g., g_{CRC24C}(D) for L=24) to generate the CRC 215 with a length of L bits (e.g., p₀, p₁, p_{L-1}). The network entity 105-a may append (e.g., attach) the CRC 215 to the payload 210 to generate B bits (e.g., b₀, b₁, b_{B-1} where B=A+L). The network entity 105-a may mask a quantity of the B bits (e.g., the last 16 bits) using an RNTI xᵣₙₜᵢ (e.g., by performing an exclusively OR (XOR) operation). The RNTI mask may allow the UE 115-a to determine one or more qualities of the DCI message 205. That is, the UE 115-a may use the RNTI mask to determine if the DCI message 205 is intended for the UE 115-a or to determine a usage (e.g., DCI format, DCI fields, or interpretation of DCI fields) of the DCI message 205. The network entity 105-a may perform one or more of interleaving, polar encoding, rate matching, scrambling, modulation, or resource element (RE) mapping (e.g., after applying the RNTI mask) of the DCI message 205 and may transmit the DCI message 205 to the UE 115-a.

In some cases, the network entity 105-a may transmit, to the UE 115-a, DCI messages 205 with CRCs 215 of a fixed length (e.g., 24 bits), as described with reference to Equation 3. However, transmitting DCI messages 205 with the CRCs 215 of the fixed length may increase overhead and processing at the UE 115-a and may limit a quantity of bits which may be allocated for other purposes. For example, false alarms for decoding DCI messages 205 associated with a first set of formats (e.g., a DCI format 2_2 for TPC commands for PUSCH or physical uplink control channel (PUCCH) transmissions) may not impact a success of future communications of the UE 115-a (e.g., may be acceptable, may not be catastrophic). As an illustrative example, a false alarm for a DCI message 205 associated with a DCI format 2_2 may result in a change in transmission power which is not indicated by the network entity 105-a, however, the change in transmission power may not impact an ability of the network entity 105-a to receive a communication from the UE 115-a. Conversely, false alarms for decoding DCI messages 205 associated with a second set of formats (e.g., a DCI format 0_0, a DCI format 0_1, a DCI format 0_2, or a DCI format 0_3 for scheduling uplink transmissions) may impact a success of future communications of the UE 115-a (e.g., may not be acceptable, may be catastrophic). As an illustrative example, a false alarm for a scheduling DCI message 205 associated with a DCI format 0_0, a DCI format 0_1, a DCI format 0_2, or a DCI format 0_3 may result in the UE 115-a transmitting an unscheduled uplink transmission (e.g., PUSCH), which may result in increased interference and inefficient use of resources.

Additionally, or alternatively, the UE 115-a may be capable of determining if a DCI message 205 has been successfully decoded with a CRC 215 of a length shorter than the fixed length. That is, a length of a CRC 215 to prevent false alarms (e.g., protection level) for a DCI message 205 may depend on (e.g., be a function of) a quantity of candidates (e.g., blind decodes) the UE 115-a may perform per slot (e.g., as a function of SCS), a quantity of RNTIs for a candidate in a search space set, or both. For example, the UE 115-a may not perform blind decoding for some DCI messages 205 (e.g., multiplexed DCI messages 205 or a second stage DCI message 205 of two-stage DCI messages 205), and thus the UE 115-a may support decoding a CRC 215 of a length shorter than the fixed length without resulting in a false alarm. Additionally, or alternatively, the length of the CRC 215 to prevent false alarms (e.g., recommended length) may depend on an aggregation level, a size of the DCI message 205 (e.g., related to a signal to interference plus noise ratio (SINR)), a reliability metric associated with a use of the DCI message 205 (e.g., URLLC or enhanced mobile broadband (cMBB)), or any combination thereof. Thus, a CRC 215 with a length shorter than the fixed length (e.g., with 6 or 11 bits similar to UCI) may be sufficient to decode some DCI messages 205 without resulting in false alarms.

Additionally, or alternatively, some DCI messages 205 (e.g., DCI messages 205 scheduling multi-CC transmissions) may have a bit length which may not exceed a threshold quantity of bits. For example, a DCI message 205 scheduling four CCs may have a large payload 210, but may not exceed the threshold quantity of bits (e.g., the polar code for PDCCH supports up to 164 bits for a payload 210 and CRC 215), and, therefore, a CRC 215 of the fixed length may decrease a quantity of bits which may be allocated for the payload 210 of the DCI message 205. Thus, the fixed CRC length for the DCI message 205 may increase overhead and processing at the UE 115-a and may limit a quantity of bits which may be allocated for other purposes.

Accordingly, techniques described herein may enable flexible CRC 215 lengths for DCI messages 205. In other words, a network entity 105-a may transmit DCI messages 205 with CRCs 215 of variable lengths. In such cases, the network entity 105-a may select a length of a CRC 215 applied to a DCI message 205 based on (e.g., as a function of) one or more attributes of the DCI message 205. That is, the network entity 105-a may select the length of the CRC 215 based on one or more of a DCI format (e.g., for scheduling PDSCH or PUSCH or group-common DCI), a component carrier used to transmit the DCI message 205, a BWP used to transmit the DCI message 205, a SCS used to transmit the DCI message 205 (e.g., as a quantity of blind decodes is a function of SCS), an AL of the DCI message 205 (e.g., a quantity of control channel elements (CCEs)), a RNTI of the DCI message 205, a type of RNTI of the DCI message 205, or a size of a payload 210 of the DCI message 205. For example, the network entity 105-a may determine to use a CRC 215-a with a length of 24 bits for a DCI message 205-a associated with a cell-RNTI (C-RNTI), and a CRC 215-b with a length of 16 bits for a DCI message 205-b associated with a TPC-PUSCH-RNTI or a TPC-PUCCH-RNTI. Additionally, or alternatively, the network entity 105-a may determine to use a CRC 215-a with a length of 24 bits for a DCI message 205-a with a payload 210-a and a CRC 215-b with a length of 16 bits for a DCI message 205-b with a payload 210-b, where a size of the payload 210-b is larger than a size of the payload 210-a.

Additionally, or alternatively, a length of a CRC 215 may depend on a CORESET, a search space set, or both, in which the UE 115-a receives a DCI message 205. That is, the network entity 105-a may select the length of the CRC 215 based on an identification (ID) associated with the CORESET, an ID associated with the search space set, a bandwidth of the CORSET, a periodicity (e.g., quantity of monitoring occasions for a search space set) associated with the search space set, a type (e.g., common or UE-specific) of the search space set, a search space set group (SSSG) (e.g., in an example of SSSG switching) associated with the search space set, or any combination thereof.

Additionally, or alternatively, the network entity 105-a may select a length of a CRC 215 based on if a DCI message 205 is a second stage DCI message 205 of a two-stage DCI message 205. For example, for two-stage DCI messages 205 (e.g., sidelink control information (SCI) 1 or SCI 2 or Uu), a first stage DCI message 205, such as the DCI message 205-a, may indicate a portion of (e.g., some) scheduling parameters for a scheduled data channel (e.g., resource allocation, modulation and coding scheme (MCS), etc.) and parameters for decoding a second stage DCI message 205, such as the DCI message 205-b (e.g., format, size, starting location, a quantity of REs, or AL). The DCI message 205-b may indicate remaining scheduling parameters for the scheduled data channel (e.g., hybrid automatic repeat request (HARQ) process ID, or network data interface (NDI)). In such cases, the UE 115-a may not perform (e.g., refrain from performing) blind decoding for the DCI message 205-b (e.g., or a quantity of blind decoding candidates or hypotheses may be reduced) based on the parameters indicated in the DCI message 205-a, and thus a CRC 215-b of a smaller length (e.g., as compared to the fixed length) may not result in a high (e.g., large) false alarm rate. As such, the length of the CRC 215-b may be based on the DCI message 205-b being a second stage DCI message 205. In some examples, the length of the CRC 215-a of the DCI message 205-a may be longer than the length of the CRC 215-b of the DCI message 205-b based on the DCI message 205-a being associated with a first DCI format or a first RNTI and the DCI message 205-b being associated with a second DCI format or a second RNTI different from the first DCI format or the first RNTI. The described techniques may apply to sidelink. Uu, or other two-stage control messages (e.g., in sidelink, the length of a CRC 215 for SCI 1 may be different from the length of a CRC 215 for SCI 2).

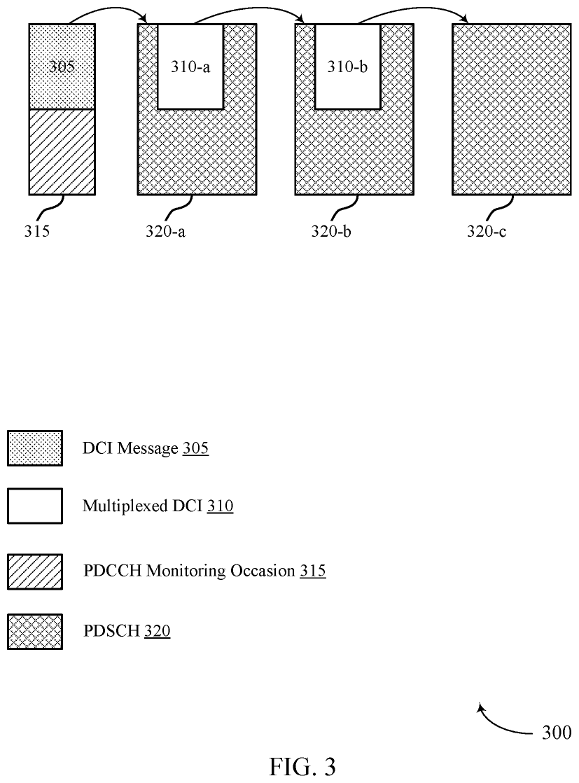

Additionally, or alternatively, the network entity 105-a may select a length of a CRC 215 based on if a DCI message 205 is multiplexed (e.g., piggybacked). For example, the CRC 215-a may be longer than the CRC 215-b based on the DCI message 205-a scheduling a PDSCH transmission and the DCI message 205-b being multiplexed with the PDSCH transmission scheduled by the DCI message 205-a, as described in further detail with reference to FIG. 3.

In some examples, the network entity 105-a (e.g., and the UE 115-a) may select the CRC length according to one or more rules (e.g., a rule defined by a wireless communications standard, such as 3rd Generation Partnership Project (3GPP) standard). For example, the one or more rules may define a length of a CRC 215 as a function of one or more attributes of a DCI message 205, as described previously. For example, a rule may indicate for the network entity 105-a to use a CRC 215-a with a length of 24 bits for a DCI message 205-a with a DCI format 0_0, a DCI format 0_1, a DCI format 0_2, a DCI format 1_0, a DCI format 1_1, or a DCI format 1_2 and to use a CRC 215-b with a length of 16 bits for a DCI message 205-b with a DCI format 2_2 or a DCI format 2_3. Additionally, or alternatively, a rule may define one or more thresholds associated with an attribute of a DCI message 205.

In some examples, the network entity 105-a may transmit, to the UE 115-a, an indication (e.g., configuration) of the CRC length (e.g., via RRC signaling). For example, the network entity 105-a may configure the UE 115-a with a CRC length for a given CC, BWP, CORESET, search space set, AL, or DCI format, among other attributes associated with a DCI message 205. Additionally, or alternatively, the network entity 105-a may indicate, to the UE 115-a, a CRC generator polynomial (e.g., separate from or in addition to a desired CRC length). That is, a length of a CRC 215 may be based on an associated CRC generator polynomial. As such, modifying a CRC generator polynomial may modify a length of the CRC 215. Thus, the network entity 105-a may indicate a CRC generator polynomial associated with a length (e.g., desired length) of a CRC 215.

In some examples, multiple CRC lengths for different DCI messages 205 (e.g., PDCCH candidates) may increase complexity at the UE 115-a (e.g., as a result of increased memory for multiple CRC generator polynomials with different lengths and increased processing for performing multiple CRCs). Thus, the UE 115-a may transmit, to the network entity 105-a, an indication of a capability of the UE 115-a to support flexible (e.g., variable, multiple) CRC lengths for DCI messages 205. The UE 115-a may additionally indicate a threshold quantity (e.g., a maximum quantity) of CRC lengths the UE 115-a may support for processing of DCI messages 205. The threshold quantity may be, for example, per SCS associated with the UE 115-a, per component carrier associated with the UE 115-a, per slot associated with (e.g., utilized by) the UE 115-a per CC, per PDCCH monitoring associated with (e.g., scheduled for) the UE 115-a occasion per CC, or any combination thereof. A granularity of the threshold quantity may be per UE 115, per band (e.g., frequency band) associated with (e.g., used by) the UE 115-a, per band combination associated with the UE 115-a, per feature set (FS) associated with the UE 115-a (e.g., per band associated with the UE 115-a per band combination), per feature set per component carrier (FSPC) associated with the UEs 115 (e.g., per CC associated with UE 115-a per band per band combination), or any combination thereof. The UE 115-a may transmit the indication of the capability, for example, based on establishing a connection with the network entity 105-a.

FIG. 3 shows an example of a timing diagram 300 that supports flexible CRC for downlink control channels in accordance with one or more aspects of the present disclosure. In some cases, the timing diagram 300 may implement or be implemented by aspects of the wireless communications system 100 or the wireless communications system 200. For example, timing diagram 300 may include a UE 115 and a network entity 105, which may be examples of the corresponding devices as described with reference to FIG. 1.

In some wireless communication systems, a network entity 105 may transmit a DCI message 305 to a UE 115 during a PDCCH monitoring occasion 315. The DCI message 305 may indicate scheduling information for a PDSCH 320-a and a multiplexed DCI message 310-a (e.g., multiplexed with the PDSCH 320-a). That is, the multiplexed DCI message 310-a may be piggybacked with the DCI message 305. For example, the scheduling information may include a grant and REs for the PDSCH 320-a. A subset of the REs allocated for the PDSCH 320-a may be used for the multiplexed DCI message 310-a. In such cases, the subset of the REs used for (e.g., allocated to) the multiplexed DCI message 310-a may be configured (e.g., preconfigured), fixed according to a rule, or separately indicated (e.g., by the network entity 105). The multiplexed DCI message 310-a and the PDSCH 320-a may additionally share demodulation reference signal (DMRS) ports, layers, modulation orders, or any combination thereof. In some examples, the network entity 105 may encode the multiplexed DCI message 310-a and one or more TBs carried in the PDSCH 320-a separately. The network entity 105 may transmit the PDSCH 320-a and the multiplexed DCI message 310-a together (e.g., in shared time and/or frequency resources).

The UE 115 may receive and decode the PDSCH 320-a and the multiplexed DCI message 310-a based on the scheduling information in the DCI message 305. That is, the UE 115 may receive the PDSCH 320-a (e.g., the one or more TBs) and the multiplexed DCI message 310-a together but may decode the PDSCH 320-a (e.g., the one or more TBs) and the multiplexed DCI message 310-a separately. Based on the subset of the REs allocated to the multiplexed DCI message 310-a, the UE 115 may decode the DCI message 310-a with reduced blind decoding (e.g., without performing blind decoding or with a reduced quantity of blind decoding candidates or hypotheses as compared to the DCI message 305). Thus, a length of a CRC applied to the multiplexed DCI message 310-a may be smaller than a length of the CRC applied to the DCI message 305, without resulting in a false alarm.

In some examples, the length of the CRC associated with the multiplexed DCI message 310-a may be shorter than the length of the CRC associated with the DCI message 305 based on the multiplexed DCI message 310-a being a multiplexed with the PDSCH 320-a (e.g., and being piggybacked). Additionally, or alternatively, the length of the CRC associated with the multiplexed DCI message 310-a may be shorter than the length of the CRC associated with the DCI message 305 based on the DCI message 305 being associated with a first DCI format and the multiplexed DCI message 310-a being associated with a second DCI format different from the first DCI format.

Continuing with the example of FIG. 3, the multiplexed DCI message 310-a may indicate scheduling information (e.g., a grant) for a PDSCH 320-b and a multiplexed DCI message 310-b. The UE 115 may receive and decode the multiplexed DCI message 310-b and the PDSCH 320-b with reduced blind decoding, as described with reference to the multiplexed DCI message 310-a. Thus, the length of a CRC applied to the multiplexed DCI message 310-b may be smaller than the length of the CRC applied to the DCI message 305, without resulting in a false alarm. The multiplexed DCI message 310-b may indicate scheduling information for a PDSCH 320-c.

In some examples, the described techniques may apply to sidelink, Uu, UCI, or other multiplexed control messages (e.g., an SCI 2 multiplexed on a physical sidelink shared channel (PSSCH) or a UCI multiplexed on a PUSCH).

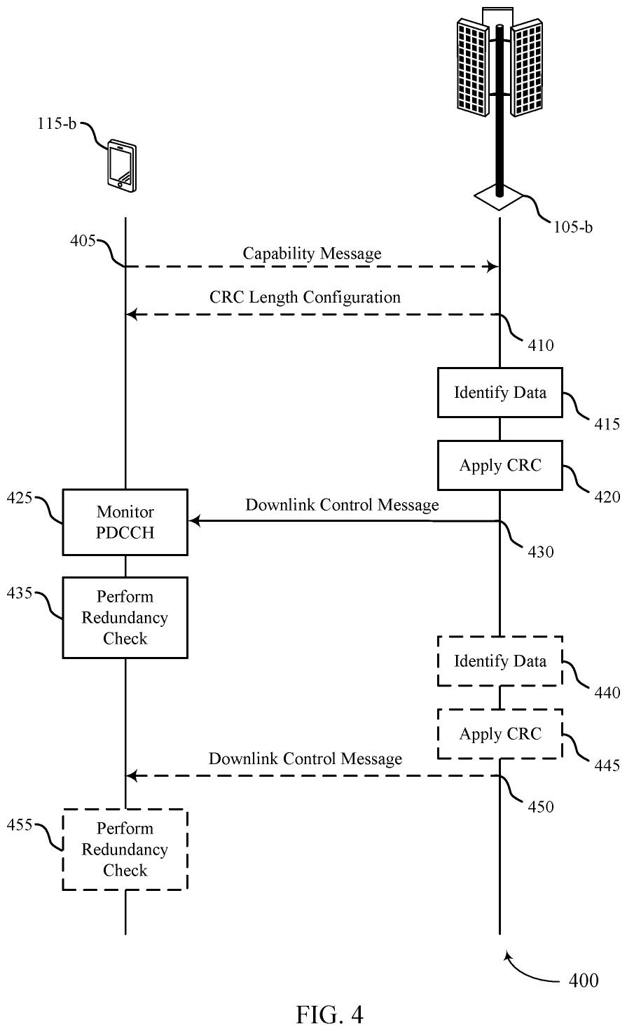

FIG. 4 shows an example of a process flow 400 that supports flexible CRC for downlink control channels in accordance with one or more aspects of the present disclosure. In some cases, the process flow 400 may implement or be implemented by aspects of the wireless communications system 100, the wireless communications system 200, and the timing diagram 300. For example, the process flow 400 may include a UE 115 (e.g., a UE 115-b) and a network entity 105 (e.g., a network entity 105-b), which may be examples of the corresponding devices as described with reference to FIG. 1.

In the following description of the process flow 400, the operations between the network entity 105-b and the UE 115-b may be transmitted in a different order than the example order shown. Some operations may also be omitted from the process flow 400, and other operations may be added to the process flow 400. Further, although some operations or signaling may be shown to occur at different times for discussion purposes, these operations may actually occur at the same time.

In some examples, at 405, the UE 115-b may transmit, to the network entity 105-b, a capability message indicating a capability of the UE 115-b to support multiple CRC lengths associated with multiple downlink control messages (e.g., DCI messages). The capability message may indicate, for example, a numerical quantity of lengths of CRC supported by the UE 115-b. The numerical quantity of lengths of CRCs may be based on one or more of an SCS associated with the UE 115-b, one or more CCs associated with the UE 115-b, one or more slots associated with the UE 115-b per CC, or one or more monitoring occasions associated with the UE 115-b per CC. In some examples, the capability may be based on one or more of a frequency band associated with the UE 115-b, a frequency band combination associated with the UE 115-b, a frequency band associated with the UE 115-b per frequency band combination, or a component carrier associated with the UE 115-b per frequency band per frequency band combination.

In some examples, at 410, the network entity 105-b may transmit, to the UE 115-b, a configuration message indicating one or more CRC lengths. For example, the configuration message may indicate a first length of a first CRC. In some examples, the network entity 105-b may transmit the configuration message via RRC signaling. Additionally, or alternatively, the network entity 105-b may determine the configuration based on the capability message. Additionally, or alternatively, the configuration message may indicate associations between a set of defined CRC lengths and one or more values of one or more transmission characteristics associated with a downlink control message. That is, each CRC length of the set of defined CRC lengths may be associated with one or more values of the one or more transmission characteristics. In some examples, the configuration may indicate a CRC generation polynomial for generating the first CRC.

At 415, the network entity 105-b may identify data for transmission in a first downlink control message (e.g., a DCI). In some examples, the first downlink control message may be a first stage downlink control message of a two-stage downlink control message. In some other examples, the first downlink control message may indicate scheduling information for a second downlink control message multiplexed with a downlink data channel (e.g., a PDSCH).

At 420, the network entity 105-b may apply a first CRC to the data. The network entity 105-b may determine (e.g., select) a length of the first CRC based on one or more transmission characteristics of the first downlink control message. For example, the network entity 105-b may determine the length of the first CRC based on one or more of CCs, one or more BWPs, or an SCS that the network entity 105-b may use to transmit the first downlink control message. Additionally, or alternatively, the network entity 105-b may determine the length of the first CRC based on a CORESET associated with a SS, the SS, an AL associated with the first downlink control message, a size of a payload of the first downlink control message, a DCI format of the first downlink control message, or an RNTI of the first downlink control message. The network entity 105-b may determine the length of the first CRC from the set of defined CRC lengths associated with the one or more transmission characteristics. In some examples, the length of the first CRC may be based on the CRC generation polynomial.

At 425, the UE 115-b may monitor the search space for the first downlink control message. At 430, the UE 115-b may receive the first downlink control message from the network entity 105-b based on monitoring the SS. For example, the UE 115-b may receive the first downlink control message on a downlink control channel monitoring occasion.

At 435, the UE 115-b may perform a redundancy check of the first downlink control message. For example, the UE 115-b may decode the first CRC and determine if the UE 115-b successfully decoded the first downlink control message. The length of the first CRC may be based on one or more transmission characteristics, as described with reference to step 420.

In some examples, at 440, the network entity 105-b may identify second data for transmission to the UE 115-b in a second downlink control message. The second downlink control message may be a second stage downlink control message. In some examples, the second downlink control message may be multiplexed with a downlink data channel (e.g., a PDSCH). In some examples, the first downlink control message may indicate scheduling information for the second downlink control message.

In some examples, at 445, the network entity 105-b may apply a second CRC to the second data. The network entity 105-b may determine the length of the second CRC based on one or more transmission characteristics of the second control message. In some examples, a length of the second CRC may be different than the length of the first CRC. For example, the network entity 105-b may determine the length of the second CRC based on a DCI format or an RNTI of the second downlink control message being different from a DCI format or an RNTI of the first downlink control message. In some examples, the network entity 105-b may determine the length of the second CRC based on the second downlink control message being a second stage downlink control message or based on the second downlink control message being multiplexed with the downlink data channel.

In some examples, at 450, the network entity 105-b may transmit the second downlink control message to the UE 115-b. For example, the network entity 105-b may multiplex the second downlink control message with the downlink data channel.

In some examples, at 455, the UE 115-b may perform a redundancy check of the second downlink control message. For example, the UE 115-b may decode the second CRC and determine if the UE 115-b successfully decoded the second downlink control message. The length of the second CRC may be based on one or more transmission characteristics, as described with reference to step 420.

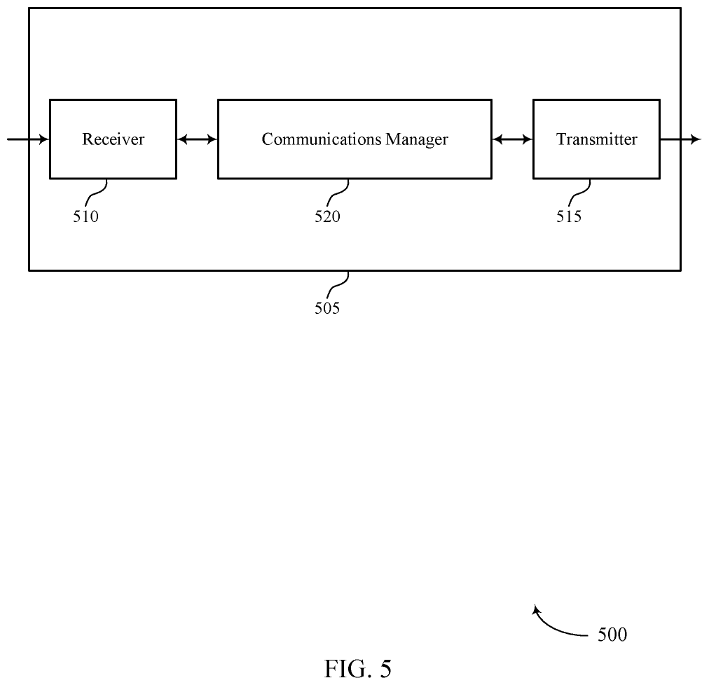

FIG. 5 shows a block diagram 500 of a device 505 that supports flexible CRC for downlink control channels in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to flexible CRC for downlink control channels). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to flexible CRC for downlink control channels). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of flexible CRC for downlink control channels as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software) executed by a processor. If implemented in code executed by a processor, the functions of the communications manager 520, the receiver 510, the transmitter 515, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 is capable of, configured to, or operable to support a means for monitoring a search space for a first downlink control message. The communications manager 520 is capable of, configured to, or operable to support a means for receiving the first downlink control message based on the monitoring. The communications manager 520 is capable of, configured to, or operable to support a means for performing a redundancy check associated with the first downlink control message based on a first CRC, where a length of the first CRC is based on one or more transmission characteristics of the first downlink control message.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for flexible CRC length for downlink control channels, which may result in reduced processing, reduced power consumption, and more efficient utilization of communication resources.

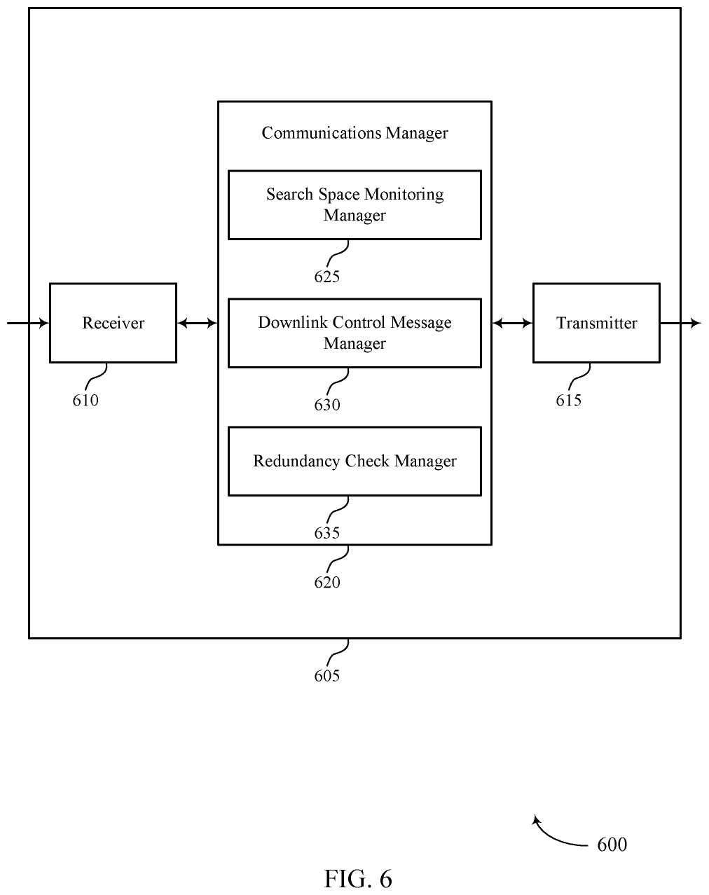

FIG. 6 shows a block diagram 600 of a device 605 that supports flexible CRC for downlink control channels in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to flexible CRC for downlink control channels). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to flexible CRC for downlink control channels). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of flexible CRC for downlink control channels as described herein. For example, the communications manager 620 may include a search space monitoring manager 625, a downlink control message manager 630, a redundancy check manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The search space monitoring manager 625 is capable of, configured to, or operable to support a means for monitoring a search space for a first downlink control message. The downlink control message manager 630 is capable of, configured to, or operable to support a means for receiving the first downlink control message based on the monitoring. The redundancy check manager 635 is capable of, configured to, or operable to support a means for performing a redundancy check associated with the first downlink control message based on a first CRC, where a length of the first CRC is based on one or more transmission characteristics of the first downlink control message.

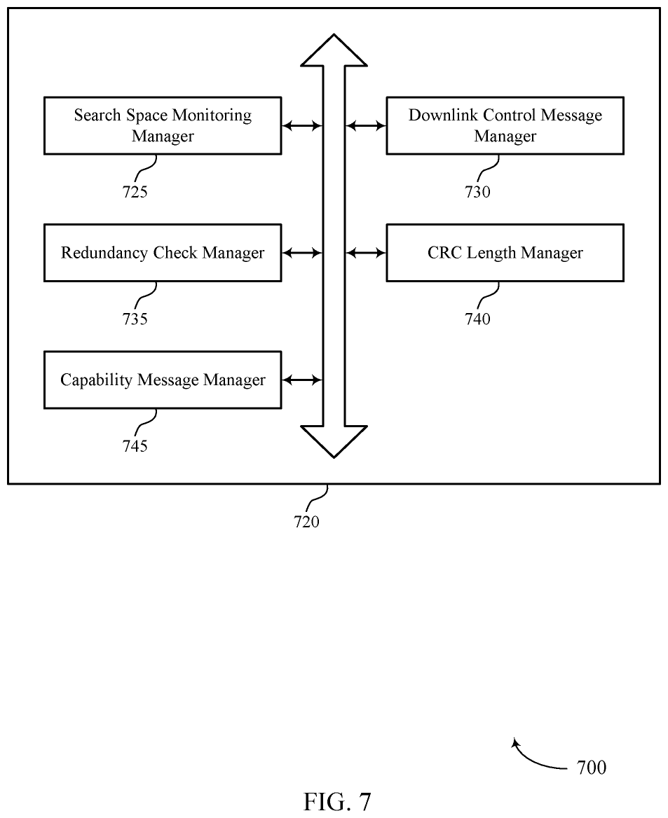

FIG. 7 shows a block diagram 700 of a communications manager 720 that supports flexible CRC for downlink control channels in accordance with one or more aspects of the present disclosure. The communications manager 720 may be an example of aspects of a communications manager 520, a communications manager 620, or both, as described herein. The communications manager 720, or various components thereof, may be an example of means for performing various aspects of flexible CRC for downlink control channels as described herein. For example, the communications manager 720 may include a search space monitoring manager 725, a downlink control message manager 730, a redundancy check manager 735, an CRC length manager 740, a capability message manager 745, or any combination thereof. Each of these components may communicate, directly or indirectly, with one another (e.g., via one or more buses).

The communications manager 720 may support wireless communications at a UE in accordance with examples as disclosed herein. The search space monitoring manager 725 is capable of, configured to, or operable to support a means for monitoring a search space for a first downlink control message. The downlink control message manager 730 is capable of, configured to, or operable to support a means for receiving the first downlink control message based on the monitoring. The redundancy check manager 735 is capable of, configured to, or operable to support a means for performing a redundancy check associated with the first downlink control message based on a first CRC, where a length of the first CRC is based on one or more transmission characteristics of the first downlink control message.

In some examples, the length of the first CRC is from a set of defined lengths of CRCs. In some examples, each length of the set of defined lengths is associated with one or more values of the one or more transmission characteristics.

In some examples, the CRC length manager 740 is capable of, configured to, or operable to support a means for receiving a configuration message indicating the associations between the set of defined lengths and the one or more values of the one or more transmission characteristics.

In some examples, the CRC length manager 740 is capable of, configured to, or operable to support a means for receiving a configuration message indicating the length of the first CRC.

In some examples, the CRC length manager 740 is capable of, configured to, or operable to support a means for receiving a configuration message indicating a polynomial associated with generating the first CRC, where the length of the first CRC is based on the polynomial associated with generating the first CRC.

In some examples, the one or more transmission characteristics include one or more component carriers used to transmit the first downlink control message, one or more bandwidth parts used to transmit the first downlink control message, a subcarrier spacing used to transmit the first downlink control message, a control resource set associated with the search space, the search space, an aggregation level associated with the first downlink control message, a size of a payload of the first downlink control message, a DCI format of the first downlink control message, a radio network temporary identifier associated with the first downlink control message, or any combination thereof.

In some examples, the downlink control message manager 730 is capable of, configured to, or operable to support a means for receiving a second downlink control message based on receiving the first downlink control message. In some examples, the redundancy check manager 735 is capable of, configured to, or operable to support a means for performing a redundancy check associated with the second downlink control message based on a second CRC, where a length of the second CRC is based on one or more transmission characteristics associated with the second downlink control message.

In some examples, the length of the first CRC is different than the length of the second CRC.

In some examples, the length of the first CRC is different than the length of the second CRC based on a format or a radio network temporary identifier associated with the first downlink control message being different than a format or a radio network temporary identifier associated with the second downlink control message.

In some examples, the first downlink control message is a first stage DCI and the second downlink control message is a second stage DCI.

In some examples, the first downlink control message is received on a downlink control channel monitoring occasion. In some examples, the second downlink control message is multiplexed with a downlink data channel.

In some examples, the capability message manager 745 is capable of, configured to, or operable to support a means for transmitting a capability message indicating a capability of the UE to support a set of multiple lengths of CRCs associated with a set of multiple downlink control messages.

In some examples, the capability message further indicates a numerical quantity of lengths of CRCs supported by the UE.

In some examples, the numerical quantity of lengths of CRC is based on a subcarrier spacing associated with the UE, one or more component carriers associated with the UE, one or more slots associated with the UE per component carrier, one or more monitoring occasions associated with the UE per component carrier, or any combination thereof.

In some examples, the capability is based on a frequency band associated with the UE, a frequency band combination associated with the UE, a frequency band associated with the UE per frequency band combination, a component carrier associated with the UE per frequency band per frequency band combination, or any combination thereof.

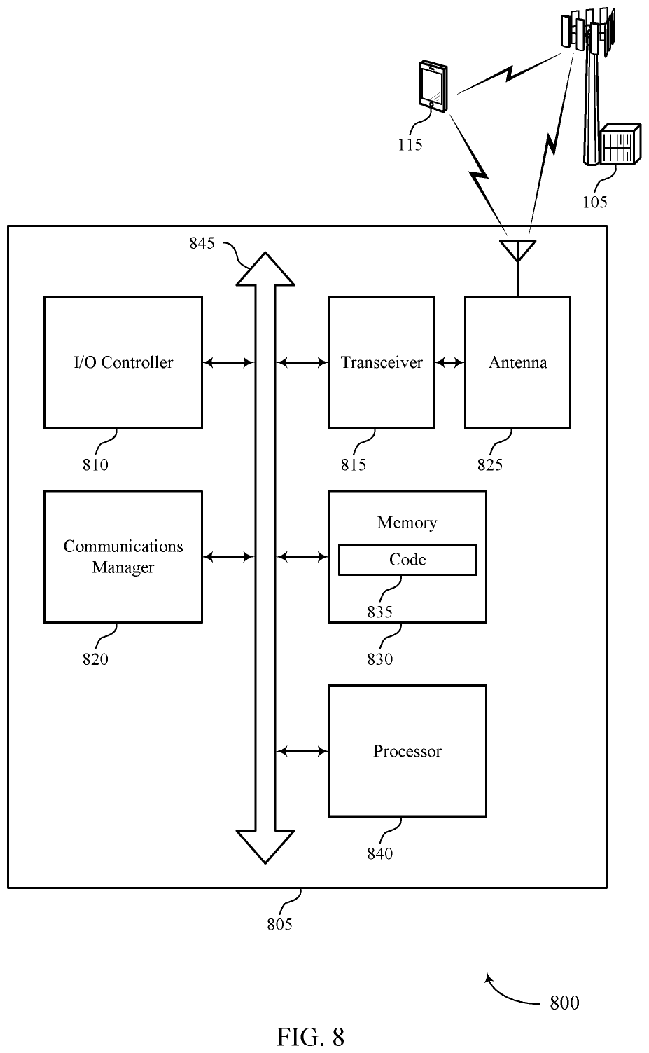

FIG. 8 shows a diagram of a system 800 including a device 805 that supports flexible CRC for downlink control channels in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting flexible CRC for downlink control channels). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 is capable of, configured to, or operable to support a means for monitoring a search space for a first downlink control message. The communications manager 820 is capable of, configured to, or operable to support a means for receiving the first downlink control message based on the monitoring. The communications manager 820 is capable of, configured to, or operable to support a means for performing a redundancy check associated with the first downlink control message based on a first CRC, where a length of the first CRC is based on one or more transmission characteristics of the first downlink control message.

By including or configuring the communications manager 820 in accordance with examples as described herein, the device 805 may support techniques for flexible CRC length for downlink control channels, which may result in improved communication reliability, reduced latency, improved user experience related to reduced processing, reduced power consumption, and more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of flexible CRC for downlink control channels as described herein, or the processor 840 and the memory 830 may be otherwise configured to perform or support such operations.

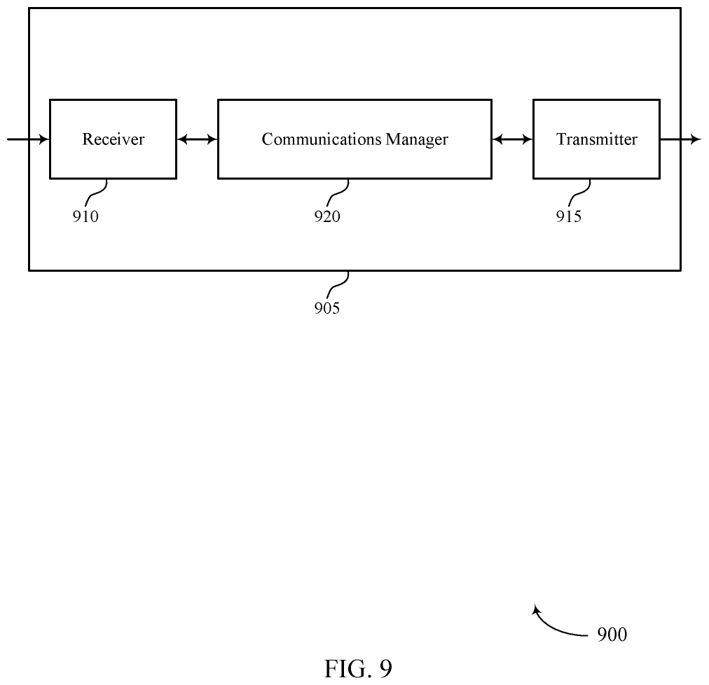

FIG. 9 shows a block diagram 900 of a device 905 that supports flexible CRC for downlink control channels in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of flexible CRC for downlink control channels as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software) executed by a processor. If implemented in code executed by a processor, the functions of the communications manager 920, the receiver 910, the transmitter 915, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 is capable of, configured to, or operable to support a means for identifying data for transmission in a first downlink control message. The communications manager 920 is capable of, configured to, or operable to support a means for applying a first CRC to the data, where a length of the first CRC is based on one or more transmission characteristics associated with the first downlink control message. The communications manager 920 is capable of, configured to, or operable to support a means for transmitting the first downlink control message via a search space based on applying the first CRC.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for flexible CRC length for downlink control channels, which may result in reduced processing, reduced power consumption, and more efficient utilization of communication resources.

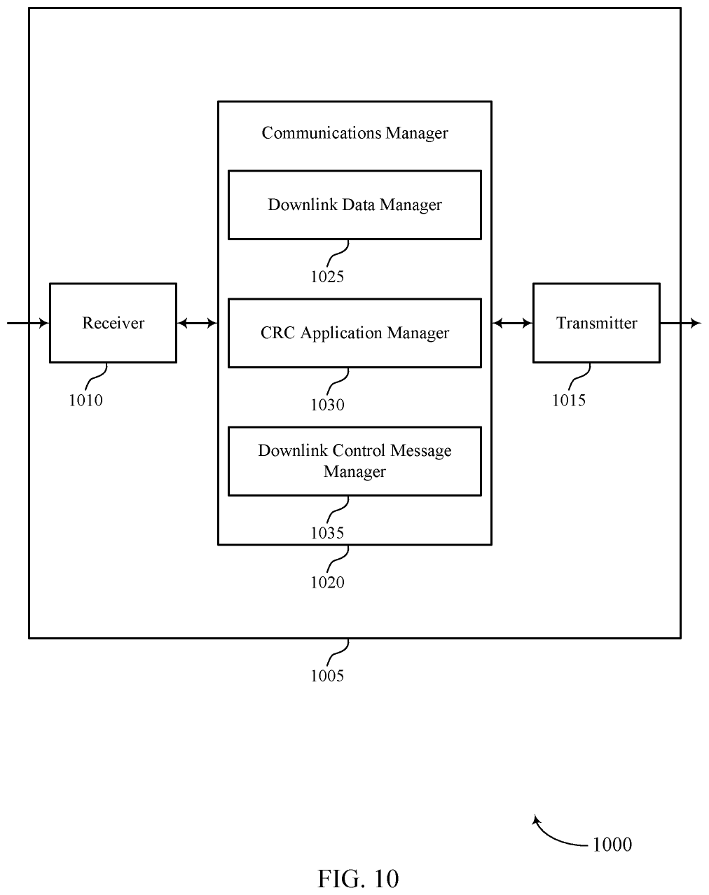

FIG. 10 shows a block diagram 1000 of a device 1005 that supports flexible CRC for downlink control channels in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of flexible CRC for downlink control channels as described herein. For example, the communications manager 1020 may include a downlink data manager 1025, an CRC application manager 1030, a downlink control message manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The downlink data manager 1025 is capable of, configured to, or operable to support a means for identifying data for transmission in a first downlink control message. The CRC application manager 1030 is capable of, configured to, or operable to support a means for applying a first CRC to the data, where a length of the first CRC is based on one or more transmission characteristics associated with the first downlink control message. The downlink control message manager 1035 is capable of, configured to, or operable to support a means for transmitting the first downlink control message via a search space based on applying the first CRC.

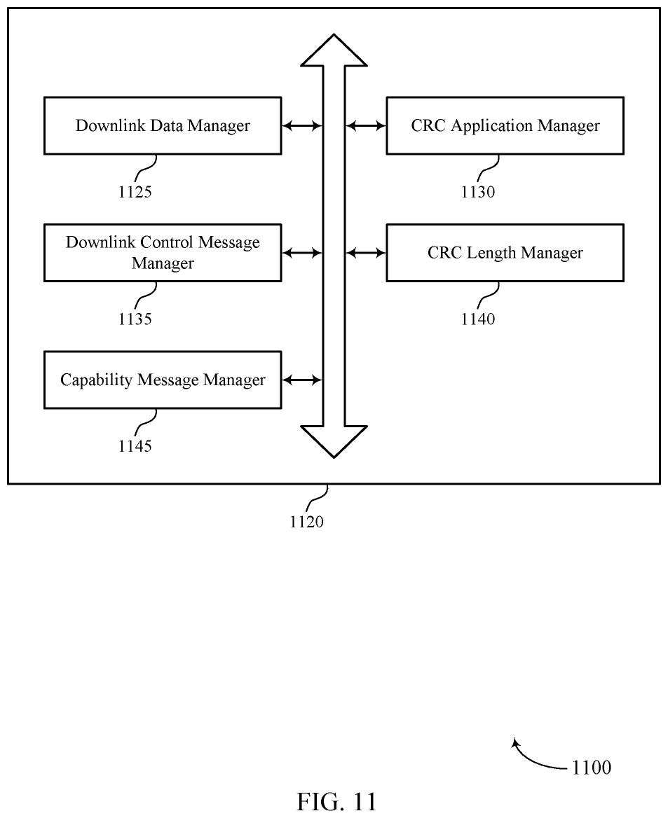

FIG. 11 shows a block diagram 1100 of a communications manager 1120 that supports flexible CRC for downlink control channels in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of flexible CRC for downlink control channels as described herein. For example, the communications manager 1120 may include a downlink data manager 1125, an CRC application manager 1130, a downlink control message manager 1135, an CRC length manager 1140, a capability message manager 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The downlink data manager 1125 is capable of, configured to, or operable to support a means for identifying data for transmission in a first downlink control message. The CRC application manager 1130 is capable of, configured to, or operable to support a means for applying a first CRC to the data, where a length of the first CRC is based on one or more transmission characteristics associated with the first downlink control message. The downlink control message manager 1135 is capable of, configured to, or operable to support a means for transmitting the first downlink control message via a search space based on applying the first CRC.

In some examples, the length of the first CRC is from a set of defined lengths of CRCs. In some examples, each length of the set of defined lengths is associated with one or more values of the one or more transmission characteristics.

In some examples, the CRC length manager 1140 is capable of, configured to, or operable to support a means for transmitting a configuration message indicating the associations between the set of defined lengths and the one or more values of the one or more transmission characteristics.

In some examples, the CRC length manager 1140 is capable of, configured to, or operable to support a means for transmitting a configuration message indicating the length of the first CRC.

In some examples, the CRC length manager 1140 is capable of, configured to, or operable to support a means for transmitting a configuration message indicating a polynomial associated with generating the first CRC, where the length of the first CRC is based on the polynomial associated with generating the first CRC.

In some examples, the one or more transmission characteristics include one or more component carriers used to transmit the first downlink control message, one or more bandwidth parts used to transmit the first downlink control message, a subcarrier spacing used to transmit the first downlink control message, a control resource set associated with the search space, the search space, an aggregation level associated with the first downlink control message, a size of a payload of the first downlink control message, a DCI format of the first downlink control message, a radio network temporary identifier associated with the first downlink control message, or any combination thereof.

In some examples, the downlink data manager 1125 is capable of, configured to, or operable to support a means for identifying second data for transmission in a second downlink control message. In some examples, the CRC application manager 1130 is capable of, configured to, or operable to support a means for applying a second CRC to the second data, where a length of the second CRC is based on one or more transmission characteristics associated with the second downlink control message. In some examples, the downlink control message manager 1135 is capable of, configured to, or operable to support a means for transmitting the second downlink control message based on transmitting the first downlink control message.

In some examples, the length of the first CRC is different than the length of the second CRC.

In some examples, the length of the first CRC is different than the length of the second CRC based on a format or a radio network temporary identifier associated with the first downlink control message being different than a format or a radio network temporary identifier associated with the second downlink control message.

In some examples, the first downlink control message is first stage DCI and the second downlink control message is second stage DCI.

In some examples, the first downlink control message is received on a downlink control channel monitoring occasion. In some examples, the second downlink control message is multiplexed with a downlink data channel.

In some examples, the capability message manager 1145 is capable of, configured to, or operable to support a means for receiving a capability message indicating a capability of a UE to support a set of multiple lengths of CRCs associated with a set of multiple downlink control messages.

In some examples, the capability message further indicates a numerical quantity of lengths of CRCs supported by the UE.

In some examples, the numerical quantity of lengths of CRC is based on a subcarrier spacing associated with the UE, one or more component carriers associated with the UE, one or more slots associated with the UE per component carrier, one or more monitoring occasions associated with the UE per component carrier, or any combination thereof.

In some examples, the capability is based on a frequency band associated with the UE, a frequency band combination associated with the UE, a frequency band associated with the UE per frequency band combination, a component carrier associated with the UE per frequency band per frequency band combination, or any combination thereof.

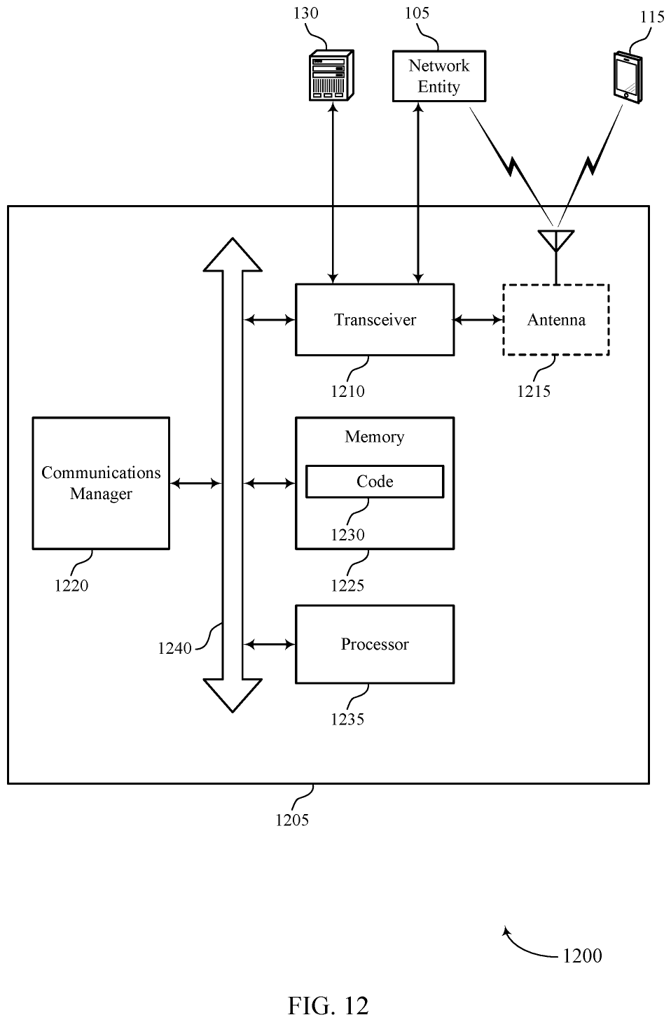

FIG. 12 shows a diagram of a system 1200 including a device 1205 that supports flexible CRC for downlink control channels in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting flexible CRC for downlink control channels). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 is capable of, configured to, or operable to support a means for identifying data for transmission in a first downlink control message. The communications manager 1220 is capable of, configured to, or operable to support a means for applying a first CRC to the data, where a length of the first CRC is based on one or more transmission characteristics associated with the first downlink control message. The communications manager 1220 is capable of, configured to, or operable to support a means for transmitting the first downlink control message via a search space based on applying the first CRC.

By including or configuring the communications manager 1220 in accordance with examples as described herein, the device 1205 may support techniques for flexible CRC length for downlink control channels, which may result in improved communication reliability, reduced latency, improved user experience related to reduced processing, reduced power consumption, and more efficient utilization of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of flexible CRC for downlink control channels as described herein, or the processor 1235 and the memory 1225 may be otherwise configured to perform or support such operations.

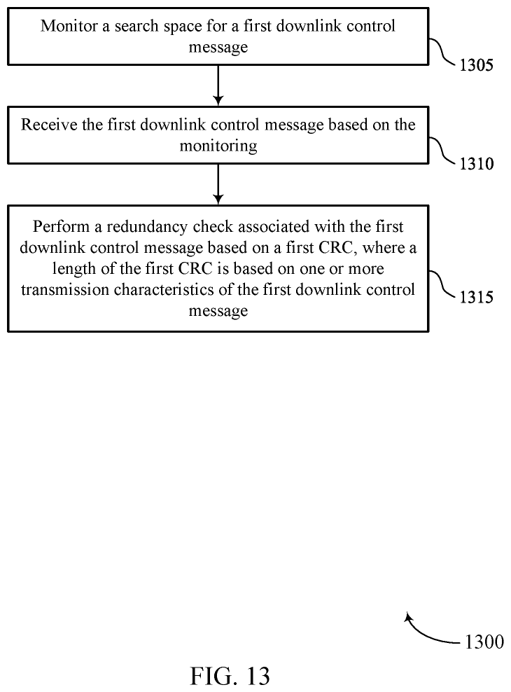

FIG. 13 shows a flowchart illustrating a method 1300 that supports flexible CRC for downlink control channels in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the wireless UE to perform the described functions. Additionally, or alternatively, the wireless UE may perform aspects of the described functions using special-purpose hardware.

At 1305, the method may include monitoring a search space for a first downlink control message. The operations of 1305 may be performed in accordance with examples as disclosed herein. In some examples, aspects of the operations of 1305 may be performed by a search space monitoring manager 725 as described with reference to FIG. 7.

At 1310, the method may include receiving the first downlink control message based on the monitoring. The operations of 1310 may be performed in accordance with examples as disclosed herein. In some examples, aspects of the operations of 1310 may be performed by a downlink control message manager 730 as described with reference to FIG. 7.

At 1315, the method may include performing a redundancy check associated with the first downlink control message based on a first CRC, where a length of the first CRC is based on one or more transmission characteristics of the first downlink control message. The operations of 1315 may be performed in accordance with examples as disclosed herein. In some examples, aspects of the operations of 1315 may be performed by a redundancy check manager 735 as described with reference to FIG. 7.

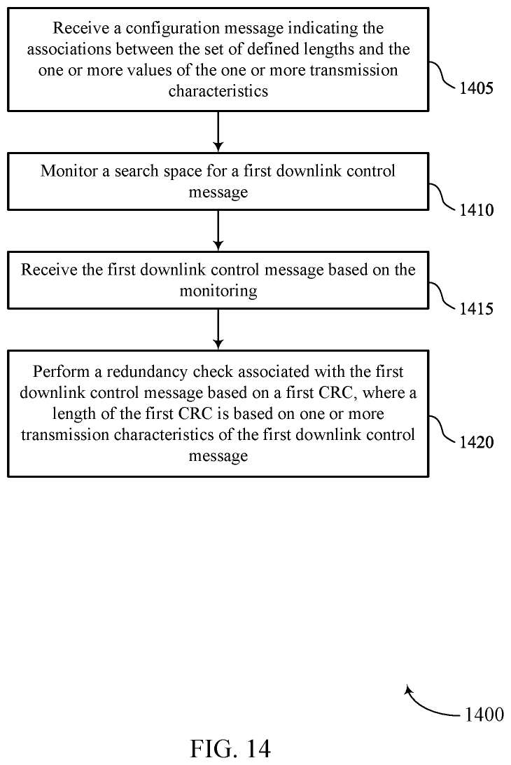

FIG. 14 shows a flowchart illustrating a method 1400 that supports flexible CRC for downlink control channels in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the wireless UE to perform the described functions. Additionally, or alternatively, the wireless UE may perform aspects of the described functions using special-purpose hardware.

At 1405, the method may include receiving a configuration message indicating associations between a set of defined lengths and one or more values of one or more transmission characteristics. The operations of 1405 may be performed in accordance with examples as disclosed herein. In some examples, aspects of the operations of 1405 may be performed by a CRC length manager 740 as described with reference to FIG. 7.

At 1410, the method may include monitoring a search space for a first downlink control message. The operations of 1410 may be performed in accordance with examples as disclosed herein. In some examples, aspects of the operations of 1410 may be performed by a search space monitoring manager 725 as described with reference to FIG. 7.

At 1415, the method may include receiving the first downlink control message based on the monitoring. The operations of 1415 may be performed in accordance with examples as disclosed herein. In some examples, aspects of the operations of 1415 may be performed by a downlink control message manager 730 as described with reference to FIG. 7.

At 1420, the method may include performing a redundancy check associated with the first downlink control message based on a first CRC, where a length of the first CRC is based on the one or more transmission characteristics of the first downlink control message. The operations of 1420 may be performed in accordance with examples as disclosed herein. In some examples, aspects of the operations of 1420 may be performed by a redundancy check manager 735 as described with reference to FIG. 7.

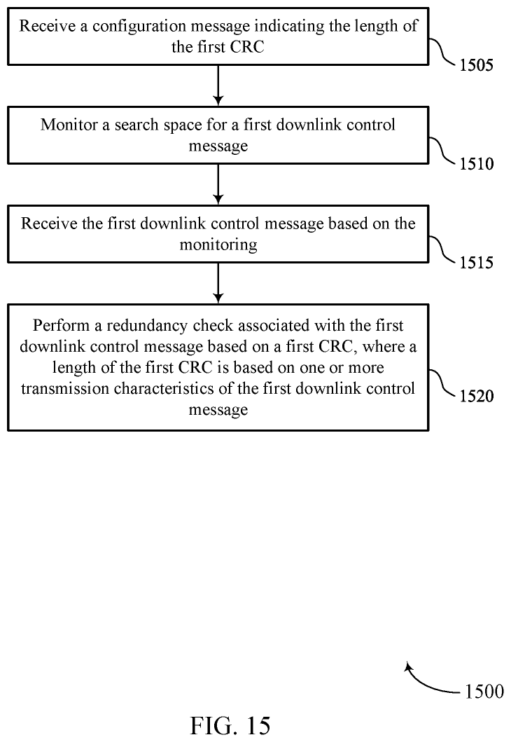

FIG. 15 shows a flowchart illustrating a method 1500 that supports flexible CRC for downlink control channels in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the wireless UE to perform the described functions. Additionally, or alternatively, the wireless UE may perform aspects of the described functions using special-purpose hardware.

At 1505, the method may include receiving a configuration message indicating a length of a first CRC. The operations of 1505 may be performed in accordance with examples as disclosed herein. In some examples, aspects of the operations of 1505 may be performed by an CRC length manager 740 as described with reference to FIG. 7.

At 1510, the method may include monitoring a search space for a first downlink control message. The operations of 1510 may be performed in accordance with examples as disclosed herein. In some examples, aspects of the operations of 1510 may be performed by a search space monitoring manager 725 as described with reference to FIG. 7.

At 1515, the method may include receiving the first downlink control message based on the monitoring. The operations of 1515 may be performed in accordance with examples as disclosed herein. In some examples, aspects of the operations of 1515 may be performed by a downlink control message manager 730 as described with reference to FIG. 7.

At 1520, the method may include performing a redundancy check associated with the first downlink control message based on the first CRC, where the length of the first CRC is based on one or more transmission characteristics of the first downlink control message. The operations of 1520 may be performed in accordance with examples as disclosed herein. In some examples, aspects of the operations of 1520 may be performed by a redundancy check manager 735 as described with reference to FIG. 7.

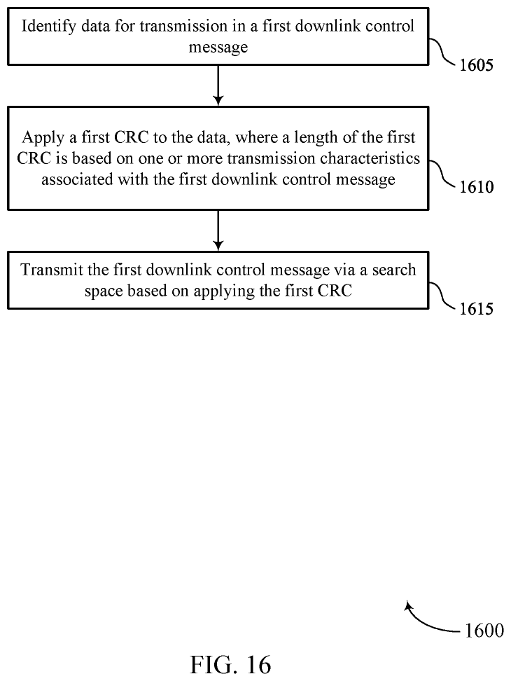

FIG. 16 shows a flowchart illustrating a method 1600 that supports flexible CRC for downlink control channels in accordance with aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the wireless network entity to perform the described functions. Additionally, or alternatively, the wireless network entity may perform aspects of the described functions using special-purpose hardware.

At 1605, the method may include identifying data for transmission in a first downlink control message. The operations of 1605 may be performed in accordance with examples as disclosed herein. In some examples, aspects of the operations of 1605 may be performed by a downlink data manager 1125 as described with reference to FIG. 11.

At 1610, the method may include applying a first CRC to the data, where a length of the first CRC is based on one or more transmission characteristics associated with the first downlink control message. The operations of 1610 may be performed in accordance with examples as disclosed herein. In some examples, aspects of the operations of 1610 may be performed by an CRC application manager 1130 as described with reference to FIG. 11.

At 1615, the method may include transmitting the first downlink control message via a search space based on applying the first CRC. The operations of 1615 may be performed in accordance with examples as disclosed herein. In some examples, aspects of the operations of 1615 may be performed by a downlink control message manager 1135 as described with reference to FIG. 11.

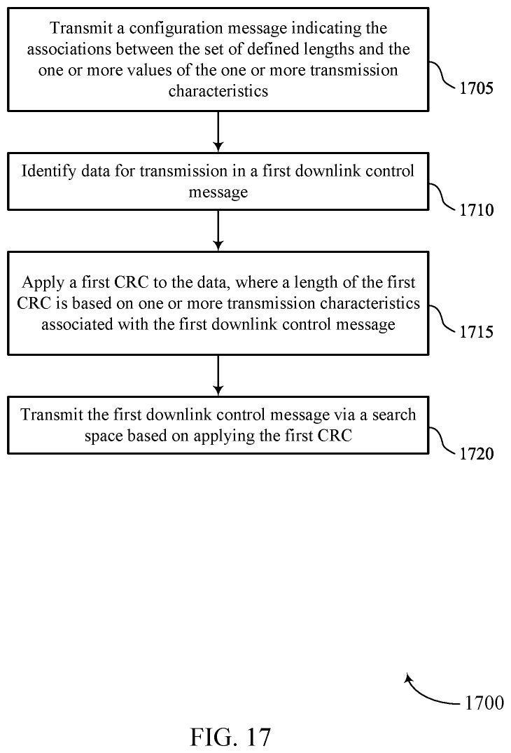

FIG. 17 shows a flowchart illustrating a method 1700 that supports flexible CRC for downlink control channels in accordance with aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the wireless network entity to perform the described functions. Additionally, or alternatively, the wireless network entity may perform aspects of the described functions using special-purpose hardware.

At 1705, the method may include transmitting a configuration message indicating associations between a set of defined lengths and one or more values of one or more transmission characteristics. The operations of 1705 may be performed in accordance with examples as disclosed herein. In some examples, aspects of the operations of 1705 may be performed by an CRC length manager 1140 as described with reference to FIG. 11.

At 1710, the method may include identifying data for transmission in a first downlink control message. The operations of 1710 may be performed in accordance with examples as disclosed herein. In some examples, aspects of the operations of 1710 may be performed by a downlink data manager 1125 as described with reference to FIG. 11.

At 1715, the method may include applying a first CRC to the data, where a length of the first CRC is based on the one or more transmission characteristics associated with the first downlink control message. The operations of 1715 may be performed in accordance with examples as disclosed herein. In some examples, aspects of the operations of 1715 may be performed by a CRC application manager 1130 as described with reference to FIG. 11.

At 1720, the method may include transmitting the first downlink control message via a search space based on applying the first CRC. The operations of 1720 may be performed in accordance with examples as disclosed herein. In some examples, aspects of the operations of 1720 may be performed by a downlink control message manager 1135 as described with reference to FIG. 11.

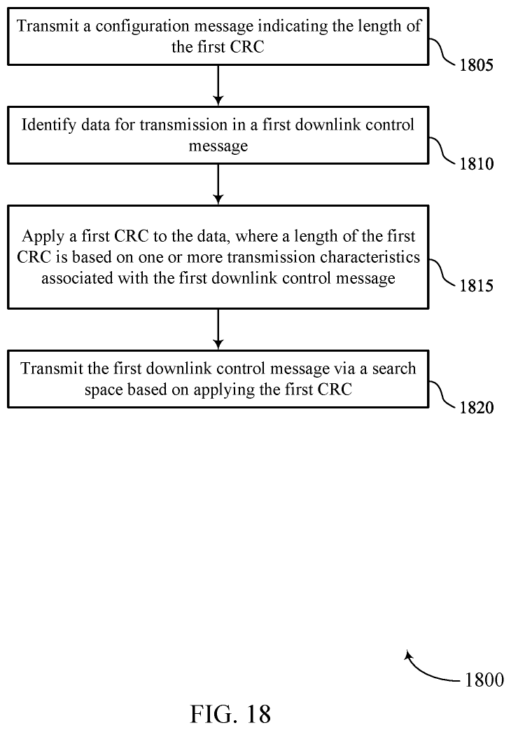

FIG. 18 shows a flowchart illustrating a method 1800 that supports flexible CRC for downlink control channels in accordance with aspects of the present disclosure. The operations of the method 1800 may be implemented by a network entity or its components as described herein. For example, the operations of the method 1800 may be performed by a network entity as described with reference to FIGS. 1 through 4 and 9 through 12. In some examples, a network entity may execute a set of instructions to control the functional elements of the wireless network entity to perform the described functions. Additionally, or alternatively, the wireless network entity may perform aspects of the described functions using special-purpose hardware.

At 1805, the method may include transmitting a configuration message indicating a length of a first CRC. The operations of 1805 may be performed in accordance with examples as disclosed herein. In some examples, aspects of the operations of 1805 may be performed by an CRC length manager 1140 as described with reference to FIG. 11.

At 1810, the method may include identifying data for transmission in a first downlink control message. The operations of 1810 may be performed in accordance with examples as disclosed herein. In some examples, aspects of the operations of 1810 may be performed by a downlink data manager 1125 as described with reference to FIG. 11.

At 1815, the method may include applying the first CRC to the data, where the length of the first CRC is based on one or more transmission characteristics associated with the first downlink control message. The operations of 1815 may be performed in accordance with examples as disclosed herein. In some examples, aspects of the operations of 1815 may be performed by an CRC application manager 1130 as described with reference to FIG. 11.

At 1820, the method may include transmitting the first downlink control message via a search space based on applying the first CRC. The operations of 1820 may be performed in accordance with examples as disclosed herein. In some examples, aspects of the operations of 1820 may be performed by a downlink control message manager 1135 as described with reference to FIG. 11.

The following provides an overview of aspects of the present disclosure:

Aspect 1: A method for wireless communications at a UE, comprising: monitoring a search space for a first downlink control message; receiving the first downlink control message based at least in part on the monitoring; and performing a redundancy check associated with the first downlink control message based at least in part on a first CRC, wherein a length of the first CRC is based at least in part on one or more transmission characteristics of the first downlink control message.

Aspect 2: The method of aspect 1, wherein the length of the first CRC is from a set of defined lengths of CRCs, and each length of the set of defined lengths is associated with one or more values of the one or more transmission characteristics.

Aspect 3: The method of aspect 2, further comprising: receiving a configuration message indicating the associations between the set of defined lengths and the one or more values of the one or more transmission characteristics.

Aspect 4: The method of any of aspects 1 through 3, further comprising: receiving a configuration message indicating the length of the first CRC.

Aspect 5: The method of any of aspects 1 through 4, further comprising: receiving a configuration message indicating a polynomial associated with generating the first CRC, wherein the length of the first CRC is based at least in part on the polynomial associated with generating the first CRC.

Aspect 6: The method of any of aspects 1 through 5, wherein the one or more transmission characteristics comprise one or more component carriers used to transmit the first downlink control message, one or more BWPs used to transmit the first downlink control message, a SCS used to transmit the first downlink control message, a CORESET associated with the search space, the search space, an AL associated with the first downlink control message, a size of a payload of the first downlink control message, a DCI format of the first downlink control message, a RNTI associated with the first downlink control message, or any combination thereof.

Aspect 7: The method of any of aspects 1 through 6, further comprising: receiving a second downlink control message based at least in part on receiving the first downlink control message; and performing a redundancy check associated with the second downlink control message based at least in part on a second CRC, wherein a length of the second CRC is based at least in part on one or more transmission characteristics associated with the second downlink control message.

Aspect 8: The method of aspect 7, wherein the length of the first CRC is different than the length of the second CRC.

Aspect 9: The method of aspect 8, wherein the length of the first CRC is different than the length of the second CRC based at least in part on a format or a RNTI associated with the first downlink control message being different than a format or a RNTI associated with the second downlink control message.

Aspect 10: The method of any of aspects 7 through 9, wherein the first downlink control message is a first stage DCI and the second downlink control message is a second stage DCI.

Aspect 11: The method of any of aspects 7 through 9, wherein the first downlink control message is received on a downlink control channel monitoring occasion, and the second downlink control message is multiplexed with a downlink data channel.

Aspect 12: The method of any of aspects 1 through 11, further comprising: transmitting a capability message indicating a capability of the UE to support a plurality of lengths of CRCs associated with a plurality of downlink control messages.

Aspect 13: The method of aspect 12, wherein the capability message further indicates a numerical quantity of lengths of CRCs supported by the UE.

Aspect 14: The method of aspect 13, wherein the numerical quantity of lengths of CRC is based at least in part on a SCS associated with the UE, one or more component carriers associated with the UE, one or more slots associated with the UE per component carrier, one or more monitoring occasions associated with the UE per component carrier, or any combination thereof.

Aspect 15: The method of any of aspects 13 through 14, wherein the capability is based at least in part on a frequency band associated with the UE, a frequency band combination associated with the UE, a frequency band associated with the UE per frequency band combination, a component carrier associated with the UE per frequency band per frequency band combination, or any combination thereof.

Aspect 16: A method for wireless communications at a network entity, comprising: identifying data for transmission in a first downlink control message; applying a first CRC to the data, wherein a length of the first CRC is based at least in part on one or more transmission characteristics associated with the first downlink control message; and transmitting the first downlink control message via a search space based at least in part on applying the first CRC.

Aspect 17: The method of aspect 16, wherein the length of the first CRC is from a set of defined lengths of CRCs, and each length of the set of defined lengths is associated with one or more values of the one or more transmission characteristics.

Aspect 18: The method of aspect 17, further comprising: transmitting a configuration message indicating the associations between the set of defined lengths and the one or more values of the one or more transmission characteristics.

Aspect 19: The method of any of aspects 16 through 18, further comprising: transmitting a configuration message indicating the length of the first CRC.

Aspect 20: The method of any of aspects 16 through 19, further comprising: transmitting a configuration message indicating a polynomial associated with generating the first CRC, wherein the length of the first CRC is based at least in part on the polynomial associated with generating the first CRC.

Aspect 21: The method of any of aspects 16 through 20, wherein the one or more transmission characteristics comprise one or more component carriers used to transmit the first downlink control message, one or more BWPs used to transmit the first downlink control message, a SCS used to transmit the first downlink control message, a CORESET associated with the search space, the search space, an AL associated with the first downlink control message, a size of a payload of the first downlink control message, a DCI format of the first downlink control message, a RNTI associated with the first downlink control message, or any combination thereof.

Aspect 22: The method of any of aspects 16 through 21, further comprising: identifying second data for transmission in a second downlink control message; applying a second CRC to the second data, wherein a length of the second CRC is based at least in part on one or more transmission characteristics associated with the second downlink control message; and transmitting the second downlink control message based at least in part on transmitting the first downlink control message.

Aspect 23: The method of aspect 22, wherein the length of the first CRC is different than the length of the second CRC.

Aspect 24: The method of aspect 23, wherein the length of the first CRC is different than the length of the second CRC based at least in part on a format or a RNTI associated with the first downlink control message being different than a format or a RNTI associated with the second downlink control message.

Aspect 25: The method of any of aspects 22 through 24, wherein the first downlink control message is first stage DCI and the second downlink control message is second stage DCI.

Aspect 26: The method of any of aspects 22 through 24, wherein the first downlink control message is received on a downlink control channel monitoring occasion, and the second downlink control message is multiplexed with a downlink data channel.

Aspect 27: The method of any of aspects 16 through 26, further comprising: receiving a capability message indicating a capability of a UE to support a plurality of lengths of CRCs associated with a plurality of downlink control messages.

Aspect 28: The method of aspect 27, wherein the capability message further indicates a numerical quantity of lengths of CRCs supported by the UE.

Aspect 29: The method of aspect 28, wherein the numerical quantity of lengths of CRC is based at least in part on a SCS associated with the UE, one or more component carriers associated with the UE, one or more slots associated with the UE per component carrier, one or more monitoring occasions associated with the UE per component carrier, or any combination thereof.

Aspect 30: The method of any of aspects 28 through 29, wherein the capability is based at least in part on a frequency band associated with the UE, a frequency band combination associated with the UE, a frequency band associated with the UE per frequency band combination, a component carrier associated with the UE per frequency band per frequency band combination, or any combination thereof.

Aspect 31: An apparatus for wireless communications at a UE, comprising at least one processor; memory coupled with the at least one processor; and instructions stored in the memory and executable by the at least one processor to cause the apparatus to perform a method of any of aspects 1 through 15.

Aspect 32: An apparatus for wireless communications at a UE, comprising at least one means for performing a method of any of aspects 1 through 15.

Aspect 33: A non-transitory computer-readable medium storing code for wireless communications at a UE, the code comprising instructions executable by at least one processor (e.g., directly, indirectly, after pre-processing, without pre-processing) to perform a method of any of aspects 1 through 15.

Aspect 34: An apparatus for wireless communications at a network entity, comprising at least one processor; memory coupled with the at least one processor; and instructions stored in the memory and executable by the at least one processor to cause the apparatus to perform a method of any of aspects 16 through 30.

Aspect 35: An apparatus for wireless communications at a network entity, comprising at least one means for performing a method of any of aspects 16 through 30.

Aspect 36: A non-transitory computer-readable medium storing code for wireless communications at a network entity, the code comprising instructions executable by at least one processor (e.g., directly, indirectly, after pre-processing, without pre-processing) to perform a method of any of aspects 16 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
at least one processor; and
memory coupled with the at least one processor, the memory storing instructions executable by the at least one processor to cause the UE to:
monitor a search space for a first downlink control message;
receive the first downlink control message based at least in part on the monitoring; and
perform a redundancy check associated with the first downlink control message based at least in part on a first cyclic redundancy check (CRC), wherein a length of the first CRC is based at least in part on one or more transmission characteristics of the first downlink control message.

2. The apparatus of claim 1, wherein the length of the first CRC is from a set of defined lengths of CRCs, and wherein each length of the set of defined lengths is associated with one or more values of the one or more transmission characteristics.

3. The apparatus of claim 2, wherein the instructions are further executable by the at least one processor to cause the UE to:
receive a configuration message indicating the associations between the set of defined lengths and the one or more values of the one or more transmission characteristics.

4. The apparatus of claim 1, wherein the instructions are further executable by the at least one processor to cause the UE to:
receive a configuration message indicating the length of the first CRC.

5. The apparatus of claim 1, wherein the instructions are further executable by the at least one processor to cause the UE to:
receive a configuration message indicating a polynomial associated with generating the first CRC, wherein the length of the first CRC is based at least in part on the polynomial associated with generating the first CRC.

6. The apparatus of claim 1, wherein the one or more transmission characteristics comprise one or more component carriers used to transmit the first downlink control message, one or more bandwidth parts used to transmit the first downlink control message, a subcarrier spacing used to transmit the first downlink control message, a control resource set associated with the search space, the search space, an aggregation level associated with the first downlink control message, a size of a payload of the first downlink control message, a downlink control information format of the first downlink control message, a radio network temporary identifier associated with the first downlink control message, or any combination thereof.

7. The apparatus of claim 1, wherein the instructions are further executable by the at least one processor to cause the UE to:
receive a second downlink control message based at least in part on receiving the first downlink control message; and
perform a redundancy check associated with the second downlink control message based at least in part on a second CRC, wherein a length of the second CRC is based at least in part on one or more transmission characteristics associated with the second downlink control message.

8. The apparatus of claim 7, wherein the length of the first CRC is different than the length of the second CRC.

9. The apparatus of claim 8, wherein the length of the first CRC is different than the length of the second CRC based at least in part on a format or a radio network temporary identifier associated with the first downlink control message being different than a format or a radio network temporary identifier associated with the second downlink control message.

10. The apparatus of claim 7, wherein the first downlink control message is a first stage downlink control information and the second downlink control message is a second stage downlink control information.

11. The apparatus of claim 7, wherein the first downlink control message is received on a downlink control channel monitoring occasion, and wherein the second downlink control message is multiplexed with a downlink data channel.

12. The apparatus of claim 1, wherein the instructions are further executable by the at least one processor to cause the UE to:
transmit a capability message indicating a capability of the UE to support a plurality of lengths of CRCs associated with a plurality of downlink control messages.

13. The apparatus of claim 12, wherein the capability message further indicates a numerical quantity of lengths of CRCs supported by the UE.

14. The apparatus of claim 13, wherein the numerical quantity of lengths of CRC is based at least in part on a subcarrier spacing associated with the UE, one or more component carriers associated with the UE, one or more slots associated with the UE per component carrier, one or more monitoring occasions associated with the UE per component carrier, or any combination thereof.

15. An apparatus for wireless communications at a network entity, comprising:
at least one processor; and
memory coupled with the at least one processor, the memory storing instructions executable by the at least one processor to cause the network entity to:
identify data for transmission in a first downlink control message;
apply a first cyclic redundancy check (CRC) to the data, wherein a length of the first CRC is based at least in part on one or more transmission characteristics associated with the first downlink control message; and
transmit the first downlink control message via a search space based at least in part on applying the first CRC.

16. The apparatus of claim 15, wherein the length of the first CRC is from a set of defined lengths of CRCs, and wherein each length of the set of defined lengths is associated with one or more values of the one or more transmission characteristics.

17. The apparatus of claim 16, wherein the instructions are further executable by the at least one processor to cause the network entity to:
transmit a configuration message indicating the associations between the set of defined lengths and the one or more values of the one or more transmission characteristics.

18. The apparatus of claim 15, wherein the instructions are further executable by the at least one processor to cause the network entity to:
transmit a configuration message indicating the length of the first CRC.

19. The apparatus of claim 15, wherein the instructions are further executable by the at least one processor to cause the network entity to:
transmit a configuration message indicating a polynomial associated with generating the first CRC, wherein the length of the first CRC is based at least in part on the polynomial associated with generating the first CRC.

20. The apparatus of claim 15, wherein the one or more transmission characteristics comprise one or more component carriers used to transmit the first downlink control message, one or more bandwidth parts used to transmit the first downlink control message, a subcarrier spacing used to transmit the first downlink control message, a control resource set associated with the search space, the search space, an aggregation level associated with the first downlink control message, a size of a payload of the first downlink control message, a downlink control information format of the first downlink control message, a radio network temporary identifier associated with the first downlink control message, or any combination thereof.

21. The apparatus of claim 15, wherein the instructions are further executable by the at least one processor to cause the network entity to:
identify second data for transmission in a second downlink control message;
apply a second CRC to the second data, wherein a length of the second CRC is based at least in part on one or more transmission characteristics associated with the second downlink control message; and
transmit the second downlink control message based at least in part on transmitting the first downlink control message.

22. The apparatus of claim 21, wherein the length of the first CRC is different than the length of the second CRC.

23. The apparatus of claim 22, wherein the length of the first CRC is different than the length of the second CRC based at least in part on a format or a radio network temporary identifier associated with the first downlink control message being different than a format or a radio network temporary identifier associated with the second downlink control message.

24. The apparatus of claim 21, wherein the first downlink control message is first stage downlink control information and the second downlink control message is second stage downlink control information.

25. The apparatus of claim 21, wherein the first downlink control message is received on a downlink control channel monitoring occasion, and wherein the second downlink control message is multiplexed with a downlink data channel.

26. The apparatus of claim 15, wherein the instructions are further executable by the at least one processor to cause the network entity to:
receive a capability message indicating a capability of a user equipment (UE) to support a plurality of lengths of CRCs associated with a plurality of downlink control messages.

27. The apparatus of claim 26, wherein the capability message further indicates a numerical quantity of lengths of CRCs supported by the UE.

28. The apparatus of claim 27, wherein the numerical quantity of lengths of CRC is based at least in part on a subcarrier spacing associated with the UE, one or more component carriers associated with the UE, one or more slots associated with the UE per component carrier, one or more monitoring occasions associated with the UE per component carrier, or any combination thereof.

29. A method for wireless communications at a user equipment (UE), comprising:
monitoring a search space for a first downlink control message;
receiving the first downlink control message based at least in part on the monitoring; and
performing a redundancy check associated with the first downlink control message based at least in part on a first cyclic redundancy check (CRC), wherein a length of the first CRC is based at least in part on one or more transmission characteristics of the first downlink control message.

30. A method for wireless communications at a network entity, comprising:
identifying data for transmission in a first downlink control message;
applying a first cyclic redundancy check (CRC) to the data, wherein a length of the first CRC is based at least in part on one or more transmission characteristics associated with the first downlink control message; and
transmitting the first downlink control message via a search space based at least in part on applying the first CRC.
